(19) United States
(12) Patent Application Publication
(10) Pub. No.: US 2015/0039330 A1
(43) Pub. Date: Feb. 5, 2015

(54) EPISODE OF CARE BUILDER METHOD AND SYSTEM

(71) Applicant: HEALTH CARE INCENTIVES IMPROVEMENT INSTITUTE, INC., Newtown, CT (US)

(72) Inventors: Amita Rastogi, Munster, IN (US); Francois de Brantes, Newtown, CT (US); Warren J. McGuire, Shelton, CT (US); Michael Moses, Upper Marlboro, MD (US); Michael Arnett, Roswell, GA (US); John Lane, Atlantic Beach, FL (US); Anthony Patton, Roswell, GA (US); Victor McLeod, Jacksonville, FL (US)

(21) Appl. No.: 14/446,670

(22) Filed: Jul. 30, 2014

Related U.S. Application Data
(60) Provisional application No. 61/860,450, filed on Jul. 31, 2013.

(51) Int. Cl. G06F 19/00

(52) U.S. Cl. CPC G06F 19/325
USPC 705/2

(57) ABSTRACT

The Episode Builder according to exemplary embodiments of the present invention is a web-based computer application and its associated architecture that allows health care professionals to define and describe episodes of care. The Episode Builder provides a unique tool for these purposes. Using industry-standard code sets, the Episode Builder describes and defines an episode of care so that the health care professional can create and modify episodes for a variety of purposes. The three main components of the Episode Builder are a configurable and extensive code set management system, a suite of display panels that define the episodes themselves based upon the code sets, and a means to export the episode definition tables thus created to be used as inputs into an analytic program or a claims adjudication engine.

### CROSS-REFERENCE TO RELATED APPLICATIONS

This application claims priority to U.S. Provisional Appl. No. 61/860,450 filed Jul. 31, 2013, which is hereby incorporated by reference in its entirety.

### TECHNICAL FIELD

The present invention is directed to an episode of care builder that allows users, especially healthcare professionals, to define and describe episodes of care.

### BACKGROUND OF THE INVENTION

An “episode of care” is a term used in the medical industry to describe all services provided to a patient with a medical problem within a specified period of time across a continuum of care in an integrated system (see “The Free Dictionary” definition of “episode of care”, at www.medical-dictionary.freedictionary.com/episode+of+care). An episode of care has also been defined as “all clinically related services for one patient for a discrete diagnostic condition from the onset of symptoms until treatment is complete (“Understanding Episodes of Care” presented by Physicians Advocacy Institute, Inc., Jun. 22, 2007).

Although episodes of care have been defined for many different diagnostic conditions, there has been a need for providing the healthcare professional the ability to modify the elements (including medical code sets described below) of an episode of care and, specifically, to provide a configurable and an extensive code set management system, as well as a suite of electronic display panels that define the episodes of care themselves based upon the code sets. Such code sets are industry-standard code sets which are used to describe and define an episode of care. It would be desirable to have an episode of care builder which allows healthcare professionals to create and modify such episodes of care for any of a variety of purposes.

### SUMMARY OF THE INVENTION

The present invention is directed to exemplary embodiments of an episode of care builder, an exemplary embodiment of which may be referred to as an Episode Builder. The Episode Builder from a user's perspective, which may be a healthcare professional, is a web-based computer application that allows one or more healthcare professionals to define, describe and modify episodes of care in a manner to efficiently and effectively suit the needs of the user. The Episode Builder makes available to the user, various sets of industry-standard medical codes to describe and define an episode of care, allowing the user to not only create the episode of care, but to modify the episode of care for any desired purpose. Two of the main components of the Episode Builder are a configurable medical code set management system, which may be referred to as a Medical Code Manager, and a computer generated suite of electronic display panels that define one or more episodes of care based on the medical code sets, which may be referred to as an Episode Editor.

The Medical Code Manager contains a library of medical codes used in documenting patient care. The codes are pre-classified into categories where these categories have been accepted by external authorities. The Medical Code Manager also allows users to manage classification and grouping of medical codes into sets of their own creation. These sets ease the creation of episodes of care by allowing users to create sets common to multiple conditions. For example, a set of procedure codes (Px) might be relevant to several cardiac related conditions each in their own episode of care. The medical code manager also allows for the management of code assignments common to all episodes within a methodology.

The Episode Editor component provides an interface where users can create, edit, review and distribute episodes of care. The Episode Editor is used within the context of a given condition classification methodology. Users can switch between methodologies to which they have rights or copy information from any methodology to use and modify within their own methodology. The user can select to create a new episode of care within that classification methodology or edit a new one. Alternatively, a user can choose to export the entire final consolidated set of episodes of care in a standardized format within the classification methodology for distribution for external review or production use for a variety of purposes including medical data analytics, cost accounting or full production bundled payment program implementation.

There are various types of medical code sets, including diagnostic codes (abbreviated Dx), procedure codes (abbreviated Px) and pharmacy codes (abbreviated Rx). The medical diagnostic code set includes alphanumeric codes to classify diseases and injuries with respect to a wide variety of signs, symptoms, abnormal findings, complaints and other indicia associated with the circumstances and causes of disease and injury. The International Classification of Diseases Clinical Modification (commonly referred to as ICD-CM) provides these alphanumeric codes and are derived from the World Health Organization's ICD, published by the U.S. Department of Health and Human Services and approved by the cooperating parties (American Hospital Association, American Health Information Management Association, Center for Medicare and Medicaid Services and National Center for Health Statistics). In addition, they provide a tabular list of common surgeries and procedures codes (Px) used in hospitals. The American Medical Association provides a listing of descriptive terms and identifying codes for reporting medical services and procedures performed by physicians called the Current Procedural Terminology (CPT®) for medical procedure codes (Px) which are industry standardized codes associated with medical procedures used on patients. Finally, the National Drug Codes (NDC) are pharmacy codes (Rx) are associated with the various pharmaceuticals that may be used to treat a patient.

These medical codes, and the time when the codes occur as submitted in medical and pharmacy claims, are the evidence that must be analyzed to determine whether or not a given patient has a given medical condition and thus the corresponding episode of care. The Episode Builder manages and automates distributed creation of patterns of medical codes and timing of these codes to describe the conditions under which an episode of care can be determined to have occurred for a given patient as well as the care that can be considered relevant to that episode of care. Since some elements of episodes of care are distinct, such as the evidence that indicates whether a given patient has one condition and not a different condition, and there is often debate about the limits of the definition of a condition in granularity or breadth, the Episode Builder allows for multiple condition classification methodologies so these differences can be explored and analyzed in their proper methodological context. The Episode Builder also standardizes distribution formats for episodes and methodologies. This standardization of the distribution formats enables any system that accepts distributions from the Episode Builder to accept any Episode Builder created methodology. The Episode Builder makes available the building blocks for an episode at the finger tips of the users and provides structure, organization, references, validation, collaboration, and distribution functionality to significantly increase process efficiency and standards consistency.

The creation and editing of a given episode of care may have three general functions: assigning episode of care parameters, grouping of medical codes and other episodes of care into episode of care function assignments, and episode quality control. In assigning episode of care parameters, the user enters global episode of care attributes such as name, type of episode (acute condition, chronic condition, etc), the types of codes or episodes of care that would indicate a condition exists for the patient and time periods around the start of a condition in which evidence should be considered as potentially condition related. The episode of care function assignment allows users to assign medical codes (or other defined episodes of care within the methodology) as relevant to the episode of care being edited. Code functions include indicating an episode of care has started, diagnosis of the condition, procedures that would occur for the condition, condition complications, associations to other conditions, drugs used for the condition, and condition subtypes. Within any code function area, the user can sort code types into pre-defined categories or user-defined groups and add the entire category or group rather than simply adding single codes.

This allows users to take advantage of the groupings and categorizations created by others while creating and editing the episodes and avoid repeating effort. For the purposes of episode of care quality control, each episode of care is reviewed by the system for problems. The user is given a list of problems or incompatibilities created by how they have assigned their codes or entered parameters. Issues include items such as codes indicating that a condition has started and insuring that this condition is distinct to a given episode of care. Otherwise, it would be possible for two episodes or more of care to start for the same condition.

In summary, the Episode Builder according to the present invention can be used for any of the following applications, including episode of care design, condition classification methodology design, medical code classification and/or standardizing episode of care formats.

### BRIEF DESCRIPTION OF THE DRAWINGS

For a further understanding and nature of the present invention, reference should be made to the following detailed description taken in conjunction with the following drawings, in which:

FIG. 1 is an illustration of the general schematic operations of an Episode Builder according to the present invention;

FIG. 2 is an exemplary cyclical flow chart of the exemplary process that may be used for defining one or more episodes of care with the Episode Builder according to the present invention;

FIG. 3 is a screen shot panel of an exemplary home page that may be used with the Episode Builder according to the present invention;

FIG. 4 is a screen shot panel of an exemplary data entry screen panel that may be used for creating one or more episodes of care with the Episode Builder according to the present invention;

FIG. 5 is a screen shot panel of an exemplary episode details panel that may be used for viewing and setting a number of episodes of care level parameters with the Episode Builder according to the present invention;

FIG. 6 is a screen shot panel of an exemplary episode trigger panel screen that may be used for setting one or more episode triggers with the Episode Builder according to the present invention;

FIG. 7 is a screen shot panel of an exemplary episode diagnosis codes panel that may be used for creating a list of all diagnosis codes with the Episode Builder according to the present invention;

FIG. 8 is a screen shot panel of an exemplary episode procedure codes panel that may be used for creating a list of all procedure codes with the Episode Builder according to the present invention;

FIG. 9 is a screen shot panel of an exemplary episode complications panel that may be used with the Episode Builder according to the present invention;

FIG. 10 is a screen shot panel of an exemplary episode association panel that may be used with the Episode Builder according to the present invention;

FIG. 11 is a screen shot panel of an exemplary episode pharmacy codes panel that may be used with the Episode Builder according to the present invention;

FIG. 12 is a screen shot panel of an exemplary episode subtype panel that may be used with the Episode Builder according to the present invention;

FIG. 13 is a screen shot panel of an exemplary notes panel that may be used with the Episode Builder according to the present invention;

FIG. 14 is a screen shot panel of an exemplary quality assurance panel that may be used with the Episode Builder according to the present invention;

FIG. 15 is a screen shot panel of an exemplary medical code manager panel that may be used with the Episode Builder according to the present invention;

FIG. 16 is simplified block diagram of an architectural overview of the Episode Building according to an embodiment of the present invention;

FIG. 17 is a flow chart illustrating Code Entity—Relationship Tables;

FIG. 17A is a full database diagram of an embodiment of the present invention presenting a global depiction of all key tables and their relationships;

FIG. 18 is a flow chart illustrating an Rx to Multum Entity-Relationship Model;

FIG. 19 is a flow chart illustrating an Episode Entity—Relationship Model;

FIG. 20 is a flow chart illustrating an Episode Association Entity—Relation Model;

FIG. 21 is a flow chart illustrating an Episode-to-Code-Relationship Model;

FIG. 22 is a flow chart illustrating a Users Entity—Relationship Model;

FIG. 23 is a table showing a list of Java Web Services;

FIG. 24 is a screen shot of an exemplary Login Form that may be used for the Episode Builder according to the present invention;

FIG. 25 is a screen shot panel of an exemplary home page that may be used with the Episode Builder according to the present invention to show a list of available episodes of care;

FIG. 26 is a screen shot panel of an exemplary data entry screen panel that may be used for creating one or more episodes of care with the Episode Builder according to the present invention;

FIG. 27 is a screen shot panel of an exemplary episode trigger panel screen that may be used for setting one or more episode triggers with the Episode Builder according to the present invention;

FIG. 28 is a screen shot panel that illustrates an exemplary working with codes panel in the Episode Editor;

FIG. 29 is a screen shot panel that illustrates an exemplary managing users panel that may be used with the Episode Editor according to the present invention

FIG. 30 is a screen shot panel of an exemplary medical code manager panel that may be used with the Episode Builder according to the present invention;

FIG. 31 is a process and information map that illustrates episode type associations;

FIG. 32 is a process and information map that illustrates data input and associated transformation;

FIG. 33 is a process and information map that illustrates episode of care building;

FIG. 34 is a process and information map that illustrates risk factor group selection and de-duplication;

FIG. 35 is a process and information map that illustrates code classification and de-duplication; and

FIG. 36 is a process and information map that illustrates episode of care validation and metadata outputs.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

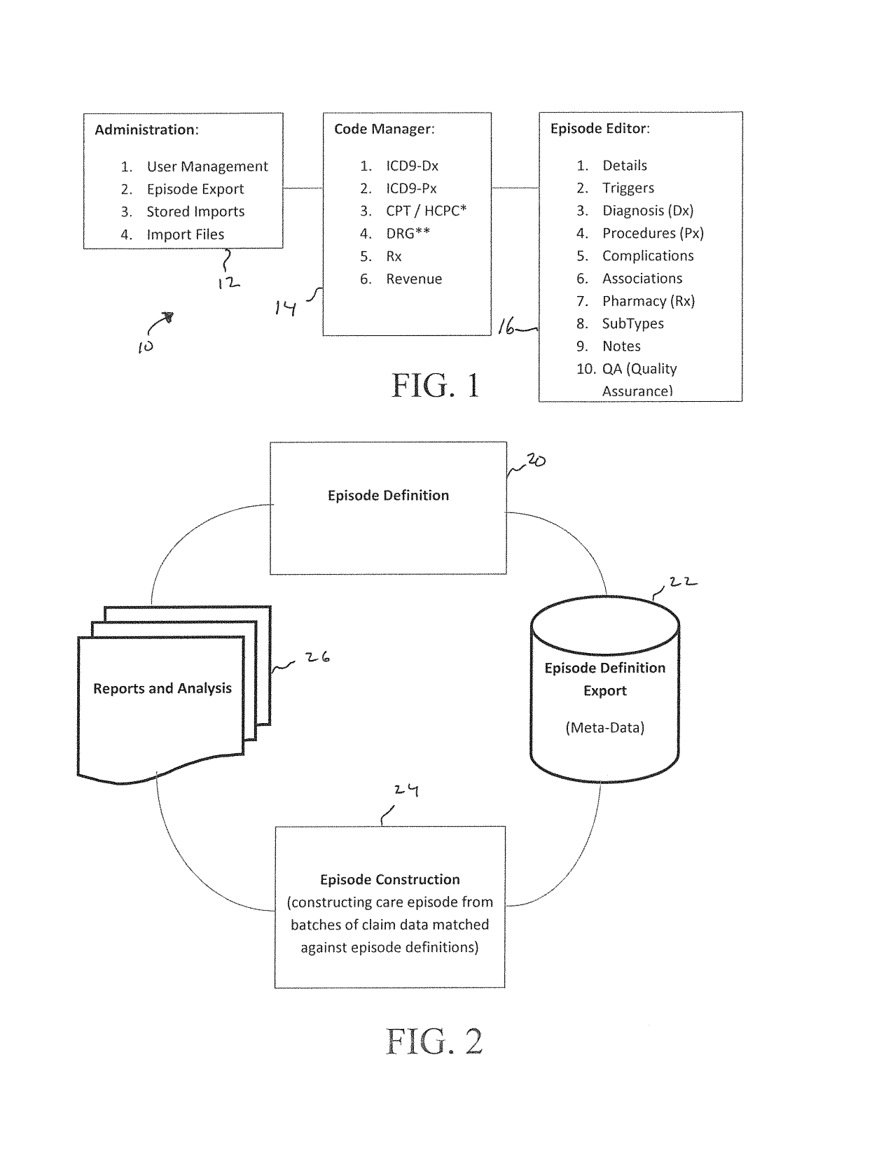

Referring now to FIG. 1, therein illustrated are the high level sections/operations that can be performed by an embodiment of the Episode Builder, generally indicated by reference numeral 10, according to the present invention. The Episode Builder 10 may include an administration section 12 that may be used to establish user passwords and profiles. The administration section 12 may also provide for administrative functions that may be used to prime some of the industry-standard code sets based upon various industry-standard transmission formats. The administration section 12 of the Episode Builder 10 may also be used to export episode of care definitions in a pre-defined meta-data format, as discussed further below. The profiles created by the administration section 12 allow for a user to create their own episode of care sets that are distinct from other users' profiles. The Episode Builder 10 may also include a medical code manager section 14 that may be used to view and organize the various diagnoses, procedural, and pharmacy code sets loaded into the Episode Builder's 10 database. The medical code manager section 14 may also provide the ability to create groups of codes in order to facilitate building episodes of care as discussed further below. The Episode Builder 10 may further include an episode editor section 16 that allow the user, for example a health care professional, to describe and define each episode of care, as discussed further below.

Still referring to FIG. 1, item No. 3 of the medical code manager section 14 refers to CPT®-Current Procedural Terminology® Medical Code Set (00000-99999). The Current Procedural Terminology (CPT) code set is maintained by the American Medical Association through the CPT Editorial Panel. The CPT code set accurately describes medical, surgical, and diagnostic services and is designed to communicate uniform information about medical services and procedures among physicians, coders, patients, accreditation organizations, and payers for administrative, financial, and analytical purposes. The current version is the CPT 2013. Furthermore, item No. 3 also identifies HCPCS Codes—Procedures, DMEs, Supplies (A0000-Z9999), which is a standardized coding system that is used primarily to identify products, supplies, and services not included in the CPT codes, such as ambulance services and durable medical equipment, prosthetics, orthotics, and supplies (DMEPOS) when used outside a physician's office. Because Medicare and other insurers cover a variety of services, supplies, and equipment that are not identified by CPT codes, the level II HCPCS codes were established for submitting claims for these items. The development and use of level II of the HCPCS began in the 1980's. Level II codes are also referred to as alpha-numeric codes because they consist of a single alphabetical letter followed by 4 numeric digits, while CPT codes (Level I codes) are identified using 5 numeric digits. Item No. 4 of the medical code manager section 14 refers to Diagnosis-related group (DRG), which is a system to classify hospital cases into one of originally 467 groups. This system of classification was developed as a collaborative project by Robert B Fetter, PhD, of the Yale School of Management, and John D Thompson, MPH, of the Yale School of Public Health. The system is also referred to as “the DRGs,” and its intent was to identify the “products” that a hospital provides. One example of a “product” is an appendectomy. The system was developed in anticipation of convincing Congress to use it for reimbursement, to replace “cost based” reimbursement that had been used up to that point. DRGs are assigned by a “grouper” program based on ICD (International Classification of Diseases) diagnoses, procedures, age, sex, discharge status, and the presence of complications or comorbidities. DRGs have been used in the U.S. since 1982 to determine how much Medicare pays the hospital for each “product,” since patients within each category are clinically similar and are expected to use the same level of hospital resources. DRGs may be further grouped into Major Diagnostic Categories (MDCs). DRGs are also standard practice for establishing reimbursements for other Medicare related reimbursements such as to home healthcare providers. While the Episode Builder 10 can be used to define and describe a single episode of care, it can also be used to define a system (group) of episodes of care that can relate to one another. The output of the Episode Builder 10 may be optimized for episodes of care to be read into the HCI³ ECR Analytics® analytical program, which is an episode system developed by Health Care Incentives Improvement Institute, 13 Sugar Street, Newtown, Conn. 06470 (HCI³). However, the outputs can also be read by any other analytical programs that perform similar functionality, i.e. grouping claims by episode of care based on the definitions of the episode of care, provided that the end user maps the Episode Builder-defined fields to their specific analytical program. Such analytical programs allow for detailed analysis of episodes of care.

The Episode Builder 10 allows the user to define all of the triggers for a given episode as a set of diagnostic codes and/or procedure codes and other ancillary considerations. This flow that users of the Episode Builder 10 may engage in is generally illustrated in FIG. 2, and includes a cycle of episode definition 20, followed by episode definition export 22, followed by claim parsing/episode construction 24 and then analysis of the results 26. The flow is shown as being cyclical in FIG. 2, because it is contemplated that even after analysis of the results 26 occurs it may be desirable to redefine and/or modify the particular episode of care, and the episode definition 20 stage may occur again. The Episode Builder 10 provides for episode definition 20 by providing panels for definition of diagnosis (Dx), procedure (Px), and pharmacy (Rx) codes normally associated with the condition or procedure. Once these codes have been defined, they are exported in a pre-defined, machine-readable format to be passed onto an analytical tool as meta-data in the episode definition export 22 phase. This meta-data can be used by an analytical tool or medical payment engine to parse batches of health care claims data into episodes of care, assigning the cost, duration in the claim parsing/episode construction 24 phase. Finally, the results of the claim parsing/episode construction 24 phase can be analyzed in the reports and analysis 26 phase to determine the effect of the generated episodes of care.

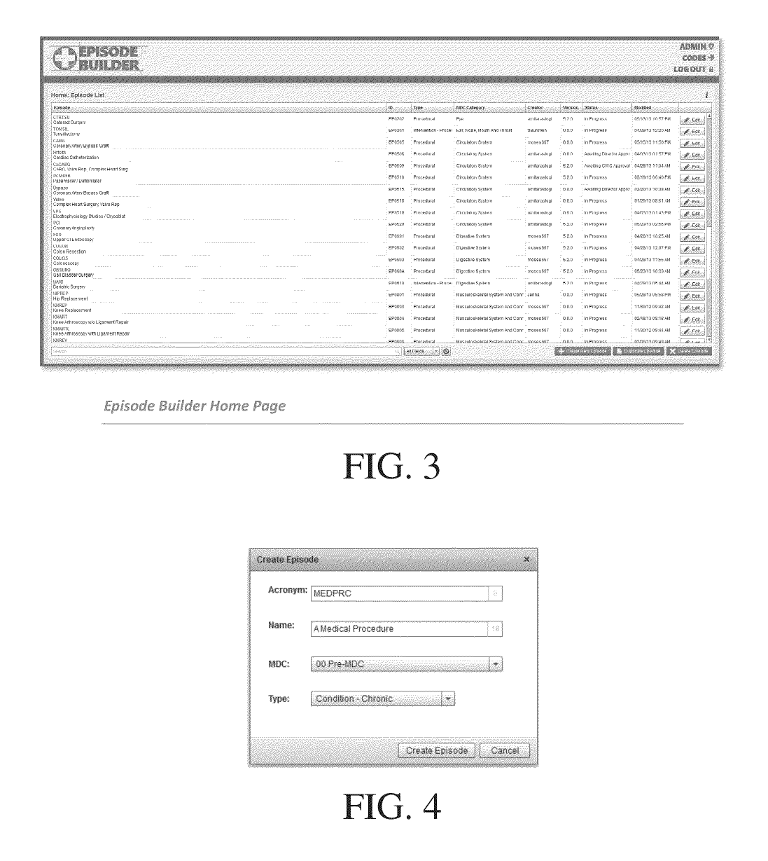

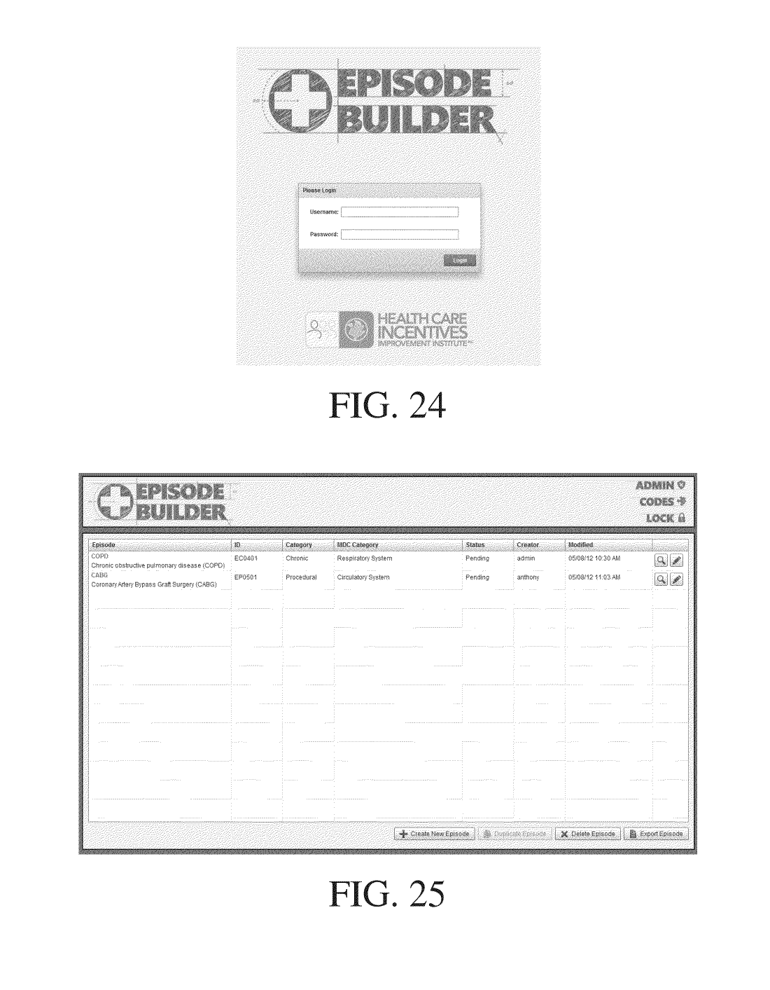

An exemplary episode of care building process or episode definition 20 as shown in FIG. 2, may begin by a user logging into the Episode Builder, for example by using the exemplary login screen shown in FIG. 24. The user may login to the Episode Builder by inputting the appropriate username and password to the designed fields of the login screen. Once the user has logged into the Episode Builder, the user may be presented with a home page, as shown for example in FIG. 3, that lists all of the episodes of care that have been constructed and/or defined to date. When presented with the home page, the user may create a new episode, duplicate an existing episode, edit an existing episode, or delete an episode. FIG. 25 also showing an exemplary home page that may be used with the Episode Builder to show existing episodes of care and allow the user to select whether to create a new episode of care, duplicate an existing episode of care, delete an episode of care or export an episode of care.

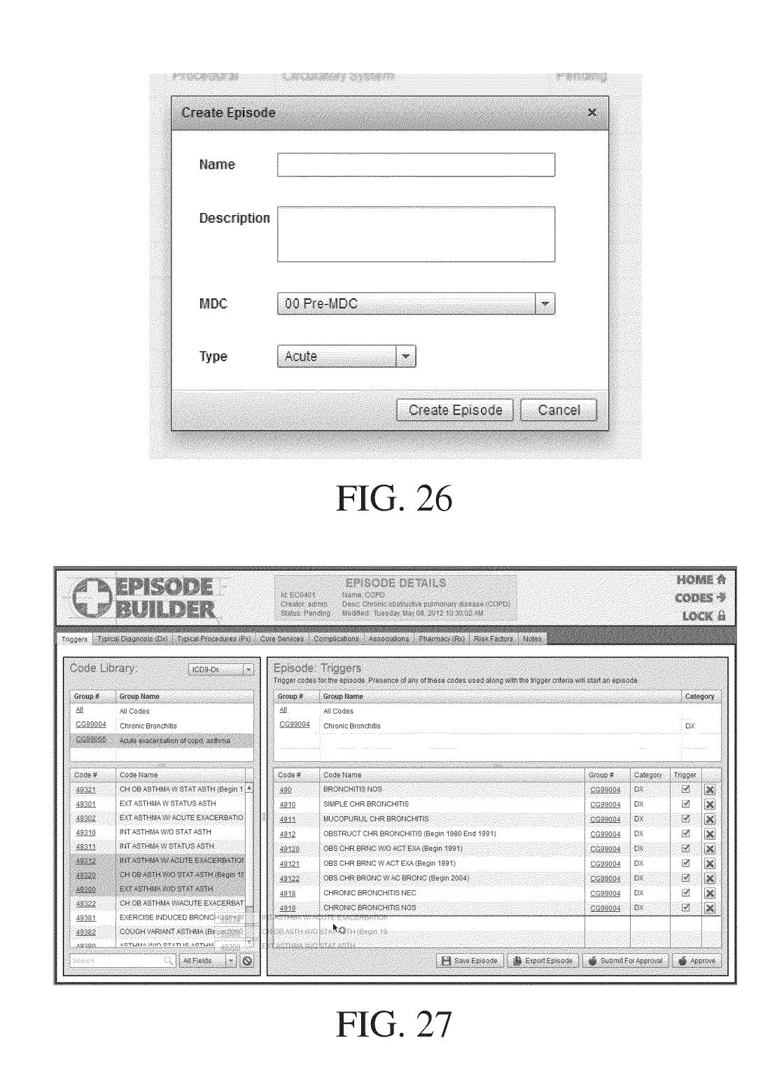

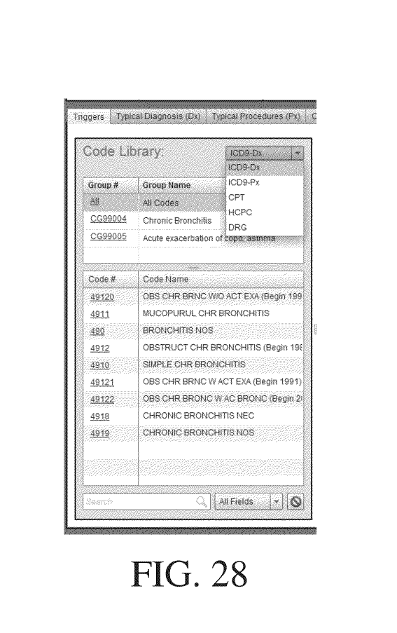

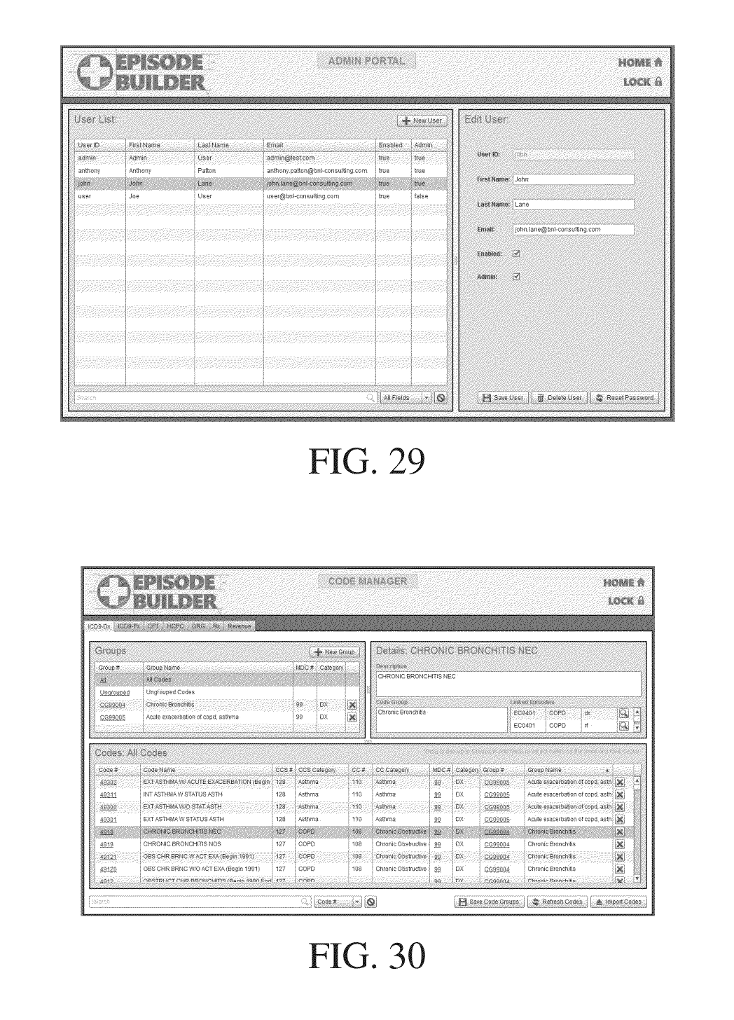

If the user decides to create a new episode of care or duplicate an existing episode, the user may be presented with a panel for entering the appropriate identifying information for creating or duplicating the episode of care, as shown for example in FIGS. 4 and 26. The panels shown in FIGS. 4 and 26 provide input fields for defining the overall episode of care type. The panels may allow the user to input an acronym, a name and/or a description for the episode of care that may be used to recall the episode of care at a later time. The panels may also include a field to input and/or select a Major Diagnostic Category (MDC), which is taken from the industry standard MDC code set. Furthermore, the panels may also include field used to select a type of episode of care. The options for type of episode of care may include, condition—chronic, condition—acute, condition—other, intervention—procedural, intervention—post acute, intervention—course of treatment or system related failure.

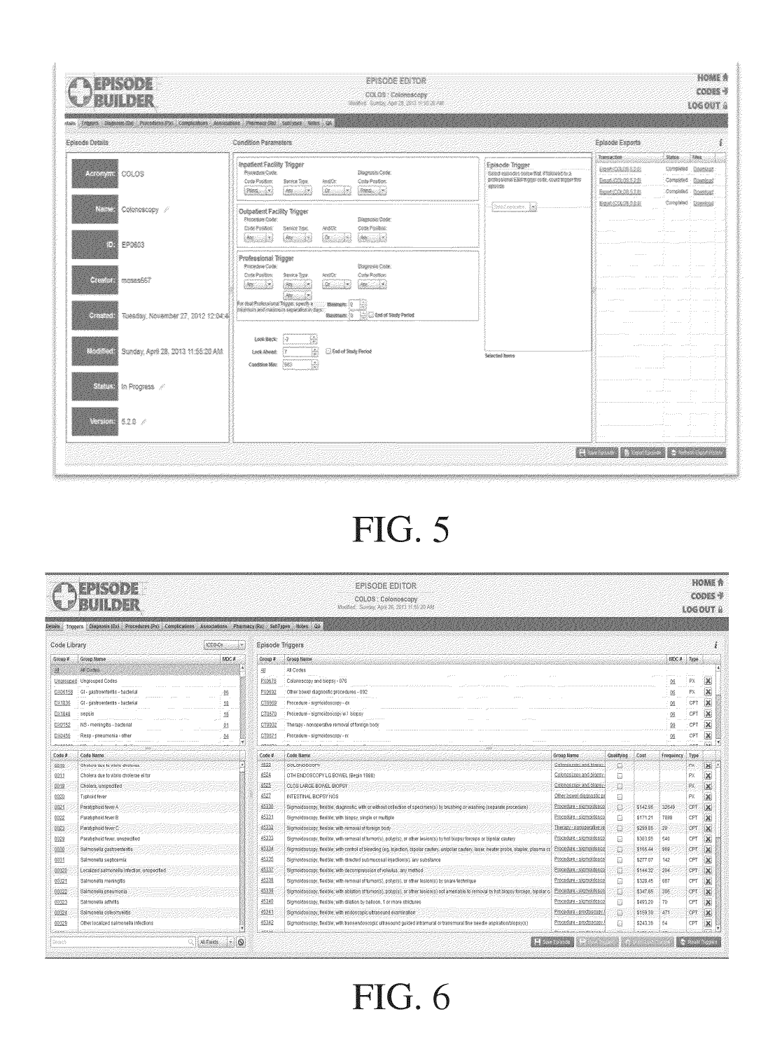

The user may view and set a number of episode of care level parameters by using an exemplary episode details panel, such as the one shown in FIG. 5, that allows for the user to select and/or input the episode of care parameters. The panel shown in FIG. 5 may also allow the user the ability to export the individual episode of care. The panel shown in FIG. 5 contains an area on the far left that shows the id, acronym, and description of the episode of care, as well as other relevant episode of care specific information. Some of these fields are editable, and will show a pencil icon next to them. The middle view on the panel is the condition parameters view, with condition values that are reflected in the output tables. The condition parameters enable the user to define criteria for starting or “triggering” an episode of care. Trigger rules for an episode of care include a combination of type of claim (inpatient, outpatient, or professional), type of code (diagnosis or procedure), code position (principal or any position on the claim), and episode triggers (e.g. where the presence of one episode can trigger another episode of care). The user can select from a variety of permutations of these fields. For example, an episode of care could be triggered by an inpatient claim with a relevant diagnosis code and procedure code, both in the principal position. The condition parameters also allow the user to specify the time window for the episode of care by indicating the number of days in the “look back” and “look ahead” fields. For instance, a user may want to capture 30 days prior to the date the episode of care triggered and 90 days after the trigger claim. Users can also specify a minimum cost for the episode definition, e.g. the episode of care must meet this minimum dollar value in order to be considered valid. The far right view is the episode export history view, which shows the most recent exports for the selected episode of care. The export history view allows any user to start a new export for the selected episode of care, as well as view previous exports, cancel in progress imports, or download completed export result files. Table 1 below identifies exemplary triggers that may be used with the Episode Builder according to the present invention.

TABLE 1

| Episode | Description | Dx Code |
|---|---|---|
| Pneumonia | ADENOVIRAL PNEUMONIA | 4800 |
| Pneumonia | RESP SYNCYT VIRAL PNEUM | 4801 |
| Pneumonia | PARINFLUENZA VIRAL PNEUM | 4802 |
| Pneumonia | VIRAL PNEUMONIA OT | 4808 |

FIG. 6 illustrates an exemplary episode triggers panel that allows the user to create a list of codes, both diagnosis (Dx) and procedure (Px) codes that can be used to trigger or start the episode of care. FIG. 27 illustrates an alternative view of the exemplary episode triggers plane. The user can see the entire library of diagnosis and procedure codes on the left of FIG. 6 individually as well as grouped in user-selected categories. The task of creating a list of triggers may be performed by dragging and dropping codes from the code library view on the left to the episode triggers view on the right. A drop down menu provides the ability to select from various categories such as from diagnosis codes (ICD9-Dx) or procedure codes (ICD9-Px; CPT/HCPC; DRG). In the upper left hand box, the code groups within the selected category are displayed. As the user highlights a given code group, the lower left panel shows only those codes included in the group. An “All Codes” group is provided to show all codes within the broader code category, and an “Ungrouped Codes” group is provided for those codes that have not been placed into a code group. As codes are dragged and dropped from left to right, the list on the right-hand side grows accordingly. In a fashion similar to the left-hand side, trigger code groups are shown in the top right panel. As each trigger code group is highlighted, the codes in that group are shown in the lower right-hand panel. The user may remove entire groups of codes by clicking on the

[symbol]

alongside the group in the upper right-hand panel. To delete a single code within a group, the user highlights the group in the upper right-hand panel or the “All codes” group, and then clicks on the [symbol]
alongside the individual code in the lower right-hand panel. Additionally, the user can indicate whether a diagnosis code that is used to trigger an episode of care is considered a “qualifying” diagnosis code. Qualifying diagnoses appear in the context of procedural episodes (e.g., Knee Replacement). The presence of a qualifying trigger diagnosis code on a claim, along with a trigger procedure code will trigger the episode of care. In other words, both a procedure code and a qualifying diagnosis code must be present for this episode of care to open. Trigger diagnosis codes that are not considered “qualifying” are able to open an episode of care by themselves. Users may decide that a procedure code alone is enough to trigger an episode of care and may choose “not” to have this criteria for defining triggers for their episodes of care. For procedural CPT trigger codes, an example of average costs and frequency from existing datasets is prepopulated to provide the user with information on approximate costs and volume for those procedure codes to help in creating episodes of care with homogenous trigger codes.

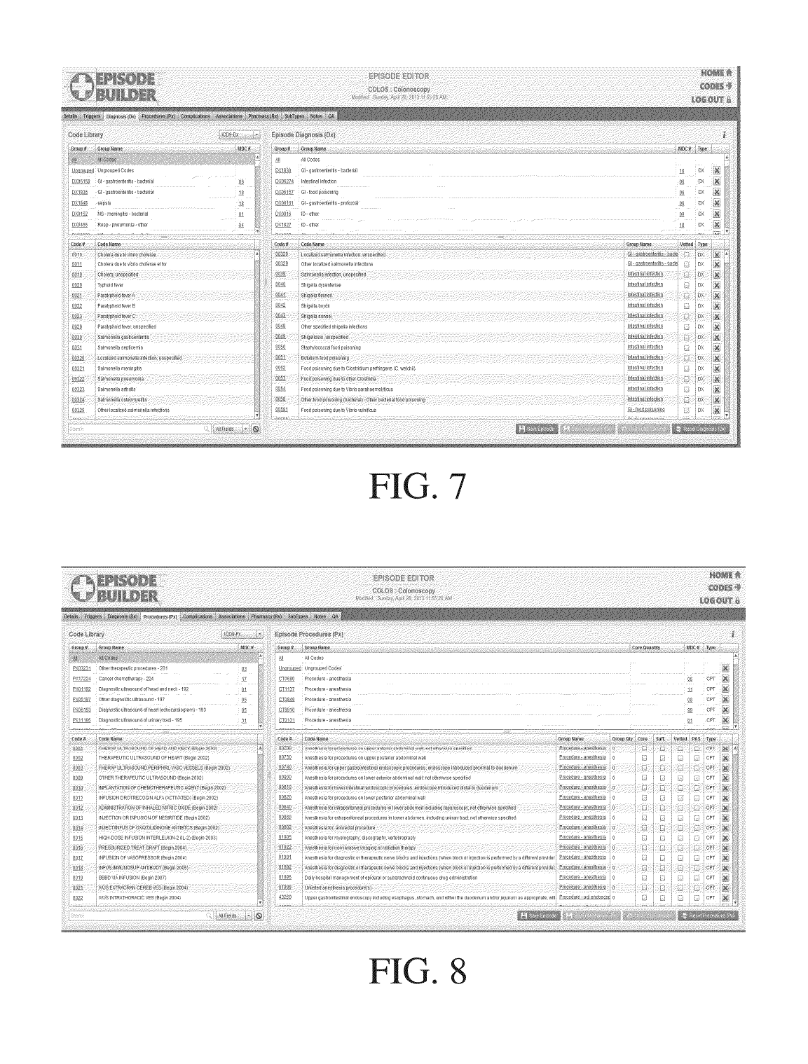

Referring now to FIG. 7, which illustrates an exemplary episode diagnosis codes panel that allows the user to create a list of all diagnosis codes (Dx) that are considered typical or routine during the course of treatment of the episode of care. The user can see the entire library of diagnosis codes on the left individually as well as grouped in user-selected categories. The task of creating a list of typical diagnosis codes requires dragging and dropping codes from the Code Library view on the left to the Episode Diagnosis (Dx) view on the right. In the upper left hand box, the complete list of diagnosis code groups are displayed. As the user highlights a given code group, the lower left panel will show only those IDC9-Dx codes included in the group. An “All Codes” group is provided to show all codes within the broader code category, and an “Ungrouped Codes” group is provided for those codes that have not been placed into a code group. As codes are dragged and dropped from left to right, the list on the right-hand side grows accordingly. In a fashion similar to the left-hand side, diagnosis code groups are shown in the top right panel. As each diagnosis code group is highlighted, the codes in that group are shown in the lower right-hand panel. The user may remove entire groups of codes by clicking on the

[symbol]

alongside the group in the upper right-hand panel. To delete a single code within a group, the user highlights the group in the upper right-hand panel or the “All codes” group, then click on the [symbol]
alongside the individual code in the lower right-hand panel. Individual typical diagnosis codes may optionally be marked as “vetted,” indicating that those diagnosis codes have been reviewed by external clinical work groups or specialty societies and have been approved for inclusion in the episode of care definition. Table 2 below shows typical diagnosis codes that may be used with the Episode Builder according to the present invention.

TABLE 2

| | | | | ICD-9 Dx | Pulm Typical |
|---|---|---|---|---|---|
| Var# | | var_label | ICD9 Diagnosis Description | code | vetted |
| 3.1.1.1.1.1.1.1.1 | CG0416 | Other Respiratory | UNSPECIFIED CHEST PAIN | 78650 | |
| | | Signs and Symptoms | | | |
| 3.1.1.1.1.1.1.1.2 | CG0416 | Other Respiratory | OTHER CHEST PAIN | 78659 | |
| | | Signs and Symptoms | | | |
| 3.1.1.1.1.1.1.1.3 | CG0408 | Strept, | MS PNEUMONIA STAPH | 48241 | x |
| | | Pneumococcal, | AUREUS | | |
| | | H. influenzae, CAP | | | |
| 3.1.1.1.1.1.1.1.4 | CG0408 | Strept, | OT STAPH PNEUMONIA | 48249 | x |
| | | Pneumococcal, | | | |
| | | H. influenzae, CAP | | | |
| 3.1.1.1.1.1.1.1.5 | CG0408 | Strept, | PNEUMOCOCCAL | 481 | x |
| | | Pneumococcal, | PNEUMONIA | | |
| | | H.influenzae, CAP | | | |

Referring now to FIG. 8, therein illustrated is an exemplary episode procedure code panel that allows the user to create a list of all procedure codes (ICD9-Px; CPT/HCPC; DRG) that would be considered typical or routine during the course of treatment of the care episode. The user can see the entire library of procedure codes (Px) on the left individually as well as grouped in user-selected categories. The task of creating a list of typical procedure codes entails dragging and dropping codes from the Code Library view on the left panel to the Episode Procedures (Px) view on the right panel. A drop down menu provides the ability to select various categories of procedural codes (ICD9-Px; CPT/HCPC; DRG). In the upper left hand box, the code groups within the selected category are displayed. As the user highlights a given code group, the lower left panel will show only those codes included in the group. An “All codes” group is provided to show all codes within the broader code category, and an “Ungrouped Codes” group is provided for those codes that have not been placed into a code group. As codes are dragged and dropped from left to right, the list on the right-hand side grows accordingly. In a fashion similar to the left-hand side, procedure code groups are shown in the top right panel. As each procedure code group is highlighted, the codes in that group are shown in the lower right-hand panel. The user may remove entire groups of codes by clicking on the

[symbol]

alongside the group in the upper right-hand panel. To delete a single code within a group, the user highlights the group in the upper right-hand panel or the “All codes” group, then clicks on the [symbol]
alongside the individual code in the lower right-hand panel.

A procedure code (Px) can be marked as “core” in order to indicate that it is a core service that is optimally required for care for a given episode of care. Chronic conditions that are defined as episodes of care consist of several core services (i.e. office visits, lab work, etc.). These codes are distinguished to ensure that a minimum dollar value related to the rendering of the core services is included in the underlying episode-of-care budget. A procedure code can also be marked as “sufficient” to convey that the presence of the code alone on a claim will pull that claim into the episode of care. Procedure codes that are not marked as sufficient often require a corresponding relevant diagnosis code (Dx) on the same claim in order to be included in the episode of care. Individual typical procedure codes may optionally be marked as “vetted,” indicating that those procedure codes have been reviewed by external clinical work groups or specialty societies and have been approved for inclusion in the episode of care definition. Procedure codes can also be marked as “PAS” for potentially avoidable service—these are codes that have been identified by specialty societies via the Choosing Wisely effort as being overused in medicine. These tags—core, sufficient, vetted and PAS—are all optional, and like any tags can be used for reporting purposes when analyzing a claims data set, or as part of the method to assign health care services to episodes of care. Their specific use would depend on the analytic program to which the Episode Builder exports its meta-data. Table 3 below shows typical procedure codes (Px) that may be used with the Episode Builder according to the present invention.

TABLE 3

| Var# | | var label | code_label | CPT_codes | Px_codes | REV_CODES | Sufficient | Vetted |
|---|---|---|---|---|---|---|---|---|
| 3.1.1.1.1.1.1.1.6 | CG0440 | anesthesia, | ANESTH, | 00520 | | | x | x |
| | | bronchoscopy | CHEST | | | | | |
| | | | PROCEDURE | | | | | |
| 3.1.1.1.1.1.1.1.7 | CG0441 | biopsy lung or | BIOPSY, LUNG | 32405 | | | x | x |
| | | mediastinum | OR | | | | | |
| | | | MEDIASTINUM | | | | | |
| 3.1.1.1.1.1.1.1.8 | CG0441 | biopsy lung or | ECHO GUIDE | 76942 | | | x | x |
| | | mediastinum | FOR BIOPSY | | | | | |
| 3.1.1.1.1.1.1.1.9 | CG0442 | blood gases | BLOOD PH | 82800 | | | x | x |
| 3.1.1.1.1.1.1.1.10 | CG0442 | blood gases | BLOOD GASES: | 82803 | | | x | x |
| | | | PH, PO2 & | | | | | |
| | | | PCO2 | | | | | |

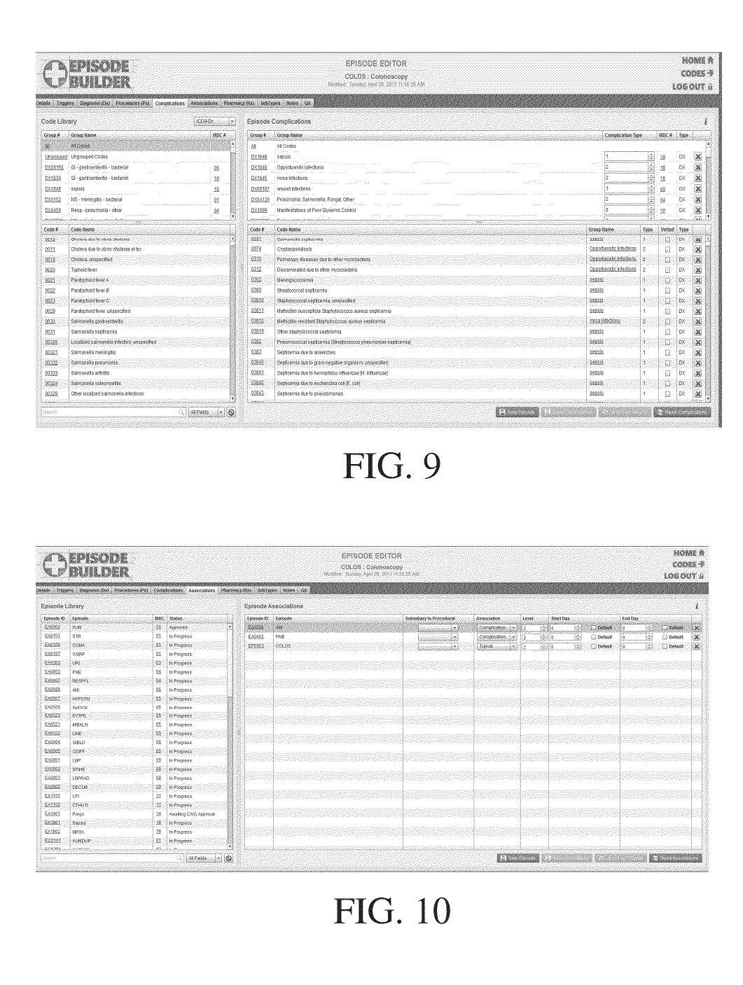

Referring now to FIG. 9, therein illustrated is an exemplary episode complications panel that allows the user to create a list of all diagnosis codes that identify complications during the course of treatment of the episode of care. The user can see the entire library of diagnosis codes on the left individually as well as grouped in user-selected categories. The task of creating a list of complications requires dragging and dropping codes from the Code Library view on the left to the Episode Complications view on the right. In the upper left hand box, the complete list of IDC9-Dx code groups are displayed. As the user highlights a given code group, the lower left panel will show only those codes included in the group. An “All Codes” group is provided to show all codes within the broader code category, and an “Ungrouped Codes” group is provided for those codes that have not been placed into a code group. As codes are dragged and dropped from left to right, the list on the right-hand side grows accordingly. In a fashion similar to the left-hand side, complication code groups are shown in the top right panel. As each diagnosis code group is highlighted, the codes in that group are shown in the lower right-hand panel. The user may remove entire groups of codes by clicking on the

[symbol]

alongside the group in the upper right-hand panel. To delete a single code within a group, the user highlights the group in the upper right-hand panel or the “All codes” group, then clicks on the [symbol]
alongside the individual code in the lower right-hand panel. Each complication code or groups of complication codes are assigned a “Complication Type” of 1 or 2, where 1=the complication that is directly related to the index condition, event, or procedure and 2=the complication that suggests a patient safety failure. This typology could also be adapted to represent a system more suited to a user's own analytic program. Table 4 below lists exemplary complications codes that may be used with the Episode Builder according to the present invention.

TABLE 4

| Var# | var_label | code_label | Dx_codes | vetted | Compl_type |
|---|---|---|---|---|---|
| CG0402 | other lung | PLEURISY WO EFFUS OR | 5110 | x | 1 |
| | complications | TB | | | |
| CG0402 | other lung | BACT PLEUR/EFFUS EX TB | 5111 | x | 1 |
| | complications | | | | |
| CG0402 | other lung | OT EFFUSION NOT TB | 5118 | x | 1 |
| | complications | | | | |
| CG0402 | other lung | UNSP PLEURAL EFFUSION | 5119 | x | 1 |
| | complications | | | | |

Referring now to FIG. 10, therein illustrated is an exemplary association logic panel that can be used to relate episodes of care to one another with the Episode Builder according to the present invention. Associations of episodes of care to one another may include five levels:
Level 1: All episodes of care are triggered at Level 1, and all service assignments occur at Level 1. An episode of care is only associated to another episode at a higher level.
Level 2: Used to merge typical associations within an episode of care family (e.g. cardiac, GI) and category (i.e., procedural or acute). For example, Colonoscopy following a Colon Resection—both are in the same episode of care family clinically (i.e. GI) and the same episode of care category or type of episode of care (i.e. procedural).
Level 3: Used to complete Procedural episodes of care. All complication associations to procedural episodes of care (i.e. procedural episode is primary) as well as any remaining typical associations to procedural episodes of care not completed at Level 2 are associated at Level 3 (i.e., post-acute care). Additionally, when an acute episode of care is both primary to another episode of care (acute or procedural) and subsidiary to a procedural episode of care (e.g., AMI and PCI), the subsidiary acute or procedural episode of care (the last episode in the chain) is associated to the acute episode of care at Level 3. The acute episode of care is also associated to the primary procedural episode of care at Level 3.
Level 4: Used to complete acute episodes of care. All complication associations to acute episodes of care (i.e. acute episode is primary) are completed at level 4, as well as any remaining typical associations to acute episodes of care not completed at Level 2 (e.g., procedural episodes, post-acute care) are associated at Level 4.
Level 5: Used to complete condition episodes of care. All complication associations to condition episodes of care (i.e. condition episode is primary) as well as any remaining typical associations to condition episodes of care not completed at Level 2 (e.g., procedural episodes) are associated at Level 5.
   In order to create a list of associations, the user drags entries from the Episode Library on the left-hand side of the panel, and drops them in the Episode Associations list on the right. Some of the options available may include:
Subsidiary to Procedural (Yes/No/<blank>): Acute and procedural episodes of care may be associated to other episodes of care at a lower level when they occur in a chain of at least 3 consecutive episodes of care. For example, a knee replacement procedure followed by an acute MI followed by a subsequent acute requires the associations to occur at a different level because the first MI is subsidiary to the knee replacement procedure. When an acute episode of care is both primary to another episode of care (acute or procedural) and subsidiary to a procedural episode of care, the subsidiary acute or procedural episode of care (the last episode of care in the chain) is associated to the acute episode of care at Level 3. The acute episode of care is also associated to the primary procedural episode at Level 3.
Association Type (Complication/Typical): The user should determine whether the episode of care that is being associated to the index or primary episode of care should be considered as typical or as a complication to that episode of care. For example a PCI episode of care would get associated to an AMI episode of care as typical but a pneumonia episode might get associated to an AMI episode of care as a complication.
Start Day and End Day: This indicates the time window of the association as it related to the date of the trigger of the primary episode of care. The default setting for Start Day is equal to the day after the trigger start date of the primary episode of care. The default setting for End Day is equal to the end date of the primary episode of care.
   While these options are defined above for use in the ECR Analytics analytical program, creating associations between episodes of care is an important part of defining a system of interrelated episodes of care. As such, there is no obligation to define these associations or to adhere to the 5 levels. A user could simply ignore this feature or use it in a manner that is consistent with their own analytic program. Table 5 below identifies exemplary associations that may be used with the Episode Builder according to the present invention.

TABLE 5

| Episode | Addln | | |
|---|---|---|---|
| Open | Episode | Clinical Logic | Rel_type |
| COPD | PNE | Pneumonia Compl for COPD | Complication |
| ASTHMA | PNE | Pneumonia Compl for Asthma | Complication |
| CHF | PNE | Pneumonia Compl for CHF | Complication |
| CABG | PNE | Pneumonia Compl for CABG | Complication |
| AMI | PNE | Pneumonia Compl for AMI | Complication |
| DIABETES | PNE | Pneumonia Compl for Diabetes | Complications |

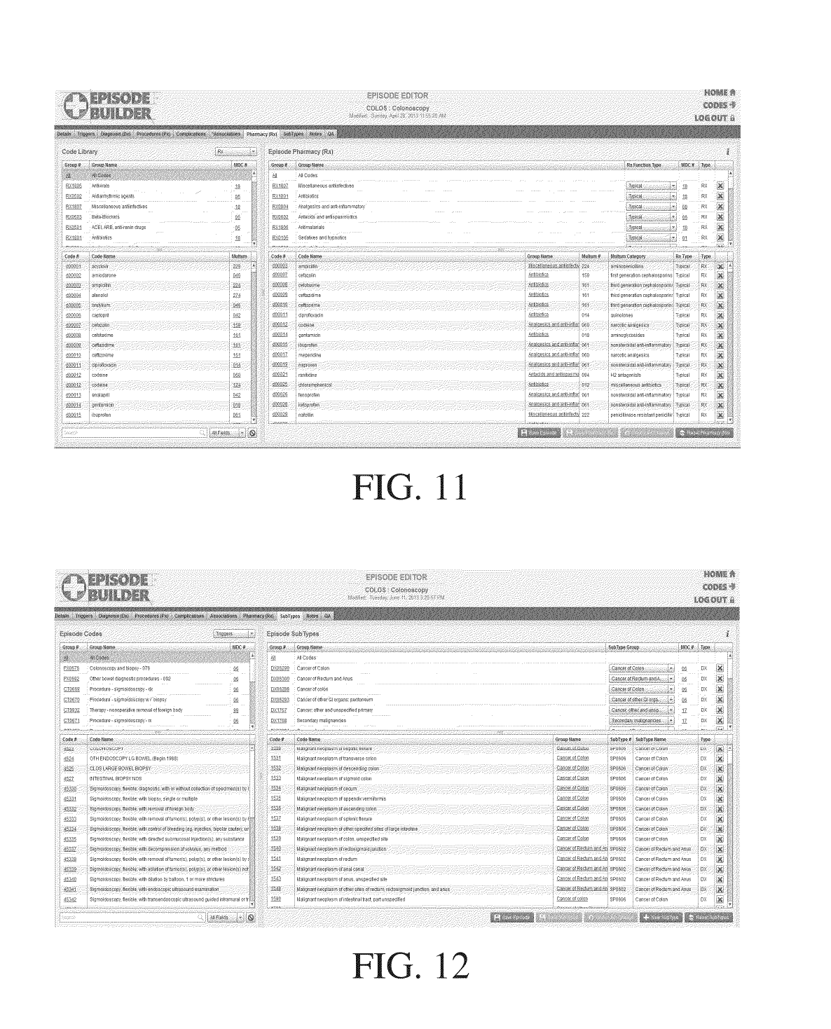

Referring now to FIG. 11, therein illustrated is an exemplary episode pharmacy codes (Rx) panel that allows the user to associate pharmacy codes with a given episode of care. Pharmacy codes (Rx) codes default to being typical for a condition. However, there is an option to define them as associated to a complication. The user can see the entire library of pharmacy codes on the left grouped in user-selected categories. The task of creating a list of pharmacy codes requires dragging and dropping codes (pre-grouped into drug IDs) from the Code Library view on the left to the Episode Pharmacy (Rx) view on the right. Drug IDs are Multum® groupings of pharmacy NDC codes and are used as an intermediary grouping to manage the huge number of pharmacy codes that get released and updated every month. In the upper left hand box, the complete list of Rx code groups are displayed. As the user highlights a given code group, the lower left will show only those drug IDs included in the group. An “All Codes” group is provided to show all drug IDs within the broader code category. As codes are dragged and dropped from left to right, the list on the right-hand side grows accordingly. In a fashion similar to the left-hand side, pharmacy code groups are shown in the top right panel. As each pharmacy code group is highlighted, the drug IDs in that group are shown in the lower right-hand panel. The user may remove entire groups of drug IDs by clicking on the

[symbol]

alongside the group in the upper right-hand panel. To delete a single drug ID within a group, the user highlights the group in the upper right-hand panel, or the All Codes group, then clicks on the [symbol]
alongside the individual drug ID in the lower right-hand panel. Table 6 below identifies exemplary episode pharmacy codes that may be used with the Episode Builder according to the present invention.

TABLE 6

| Var# | Var_label | Assignment |
|---|---|---|
| BACL1 | Anticoagulants | typical |
| BACL2 | Coagulation modifiers | typical |
| EDIAB | Anti-diabetics | typical |
| GIEM | Anti-emetics | PAC |
| HINTR | Inotropic agents and vasopressors | PAC |
| HTEMG | Agents for hypertensive emergencies | PAC |

Referring now to FIG. 12, therein illustrated is an exemplary episode subtype panel illustrates the subtypes of episodes of care that are created from episode-specific trigger codes and, in the case of procedural episodes of care, may also be derived from the qualifying diagnosis codes that are required to trigger the procedural episode of care. For example, a diabetes episode of care may have subtypes related to type 1 (juvenile) diabetes, or type 2 (maturity-onset) diabetes. In the case of procedural episodes of care, subtypes may indicate the detail about the procedure itself or the setting in which the procedure was performed. A CABG episode of care, for example, may be an isolated CABG or may be a complex procedure that had an additional Heart Valve Replacement, Ventricular Repair, or Surgery for Cardiac Arrhythmia, etc. The CABG procedure may be performed electively or it may be performed in the setting of an acute myocardial infarction (AMI). Each of these subtypes of CABG is an indicator of differing surgical intensity and may have a very different cost profile. As such, subtypes are included in the modeling process to adjust for these differences. This panel allows the user to create a list of subtypes of the episode of care. The user can see the entire library of trigger codes, typical diagnosis and typical procedure codes for the current episode of care, on the left, individually as well as grouped in user-selected categories. The task of creating a list of subtypes requires dragging and dropping codes from the Code Library view on the left to the Episode Subtypes view on the right. In the upper left hand box, the complete list of available code groups is displayed. As the user highlights a given code group, the lower left panel will show only those codes included in the group. An “All Codes” group is provided to show all codes within the broader code category. As codes are dragged and dropped from left to right, the list on the right-hand side grows accordingly. In a fashion similar to the left-hand side, subtype code groups are shown in the top right panel. As each subtype group is highlighted, the codes in that group are shown in the lower right-hand panel. The user may remove entire groups of codes by clicking on the

[symbol]

alongside the group in the upper right-hand panel. To delete a single code within a group, the user highlights the group in the upper right-hand panel, or the All codes group, then clicks on the [symbol]
alongside the individual code in the lower right-hand panel. The Subtype Group panel enables the user to group similar codes together into a larger subtype group that can be used in a severity adjustment model to create a predicted budget or expected cost of the episode. Each Subtype Group is assigned a corresponding Subtype #.

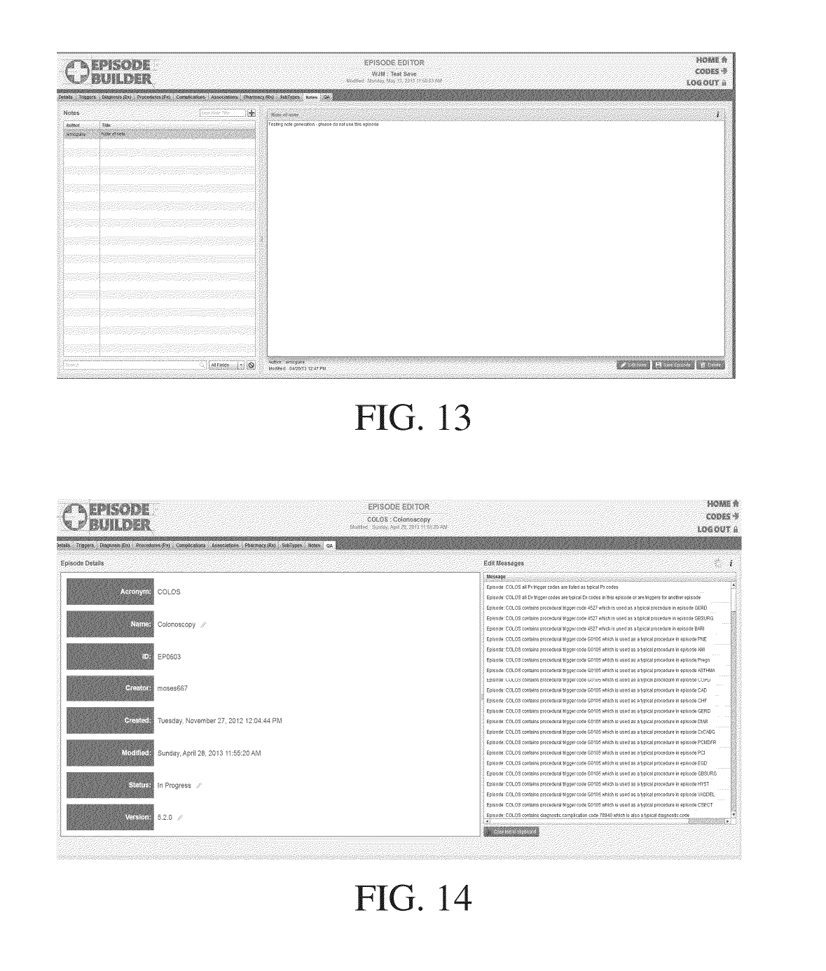

Referring now to FIG. 13, therein illustrated is an exemplary notes panel that may be used to relate any number of notes to a given episode of care. Notes may be added by using the plus sign on the upper left. As notes are added, they appear in the list on the left with the author's name and a title. All notes are listed in the panel on the right. Notes may include links and attachments. This panel allows the user to save reference articles, evidence-based guidelines, and names of specialty societies, as well as reference to experts who contributed to the development of the episode and any discussion points that led to the final decisions made in defining the boundaries of the episode.

Now referring to FIG. 14, which illustrates an exemplary episode of care quality assurance panel that can be used to apply a series of checks to an episode of care to ensure that there are no internal conflicts in the assignment of the various code values. The quality assurance panel can also be used to make a number of cross-episode of care checks to ensure that code usage across multiple episodes will not cause ambiguities during the analysis process, as episodes of care are constructed. The rules employed are:
1. Triggers: For episodes of type chronic and acute, all trigger codes should also be included as either typical or complication Dx codes. Flag any trigger codes that do not match.
2. Triggers: For procedural episodes, all procedural trigger codes should also be listed as typical procedure codes. Flag any trigger codes that do not match.
3. Triggers: For procedural episodes, all qualifying and non-qualifying Dx codes that are in the trigger tab should also be included as typical Dx codes or complications unless they are a trigger code for another episode. Flag any trigger codes that do not match.
4. Triggers: Trigger codes are distinct between episodes unless they are marked as qualifying. If any non-qualifying trigger code is found to be a trigger for more than one episode, it should be flagged.
5. Triggers: Dx triggers on chronic conditions should not appear as typical Dx or complications in other chronic condition episodes. Trigger Dx codes for acute episodes should not appear as typical Dx or complications in any other episodes. Trigger Px codes on all non-chronic care conditions should not be present as typical Px in any other episode. NOTES: (1) qualifying Dx's can appear in other episodes; (2) the trigger codes for SRF (system related failure) episodes, by definition, are supposed to match the type 2 complication codes in other episodes; and (3) Dx triggers on chronic conditions can appear as typical Dx or complications in other non-chronic conditions.
6. Dx Codes within a given episode may not be both typical and complication. Flag codes where this is the case.
7. Complication Types: zero, or any other non-allowed values should be flagged.
8. All subtypes must also be trigger codes or qualifying diagnosis codes for each episode. Flag any subtype codes that are not also trigger codes for the episode.
   Quality assurance rules can be edited and/or modified based on the needs of the user, and may be coded accordingly for the user to see the appropriate outputs.

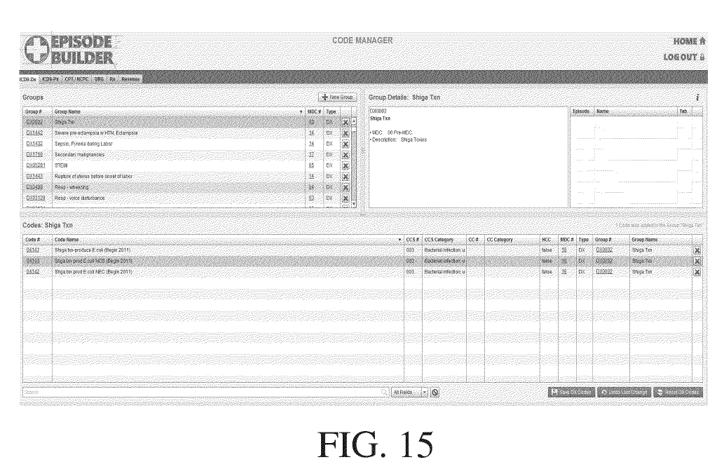

Referring now to FIG. 15, therein illustrated is an exemplary medical code manager panel that contains a library of medical codes used in documenting patient care. The codes are pre-classified into categories where these categories have been accepted by external authorities. The code manager panel also allows users to manage classification and grouping of medical codes into sets of their own creation. These sets ease the creation of episodes of care by allowing users to create sets common to multiple conditions. For example, a set of procedure codes might be relevant to several cardiac related conditions each in their own episode of care. The medical code manager also allows for the management of code assignments common to all episodes within a methodology. In order to create a new code group, the user highlights the first code he/she wishes to place in the group, clicks on the New Group icon and enters the requested descriptive information. Additional codes can then be dragged and dropped from the prior group (usually “Ungrouped”) to the desired group in the upper left-hand panel. The code manager panel also has an important functionality that allows the user to see which episodes of care any selected code is being used. The top right section of the code manager panel displays all episode of care where any selected code is being used and its assignment (trigger, typical, complication etc.). It also has a bridge to move directly from the code manager panel to a given episode of care where the selected code is being used to allow the user to see other related episodes of care assigned to the same episode of care in a similar fashion. These functionalities provide to the user a decision support system where they could leverage information from one episode to build similar or related episodes of care. Additionally, if a user decides to move a code from a code group to another, the change gets reflected in all the episodes of care where the code has been assigned. This gives consistency to the code groupings within the Episode Builder across all episodes of care. FIG. 30 also provides an illustration of an exemplary medical code manager panel.

In view of the above discussion and the accompanying figures it is understood that the Episode Builder facilitates the collaborative creation and distribution of definitions, boundaries and other characteristics of episodes of care, as well as parent condition classification methodologies. In addition, the Episode Builder facilitates the design and creation of medical condition classification methodologies, as well as the episode of care (procedural episodes) sub-components.

In particular, it is understood that the Episode Builder in operation may be used to perform the transformation of medical code libraries from various sources into a consistent set of medical code libraries that are available in XML, Excel, and SAS formats, a method that standardizes the creation and management of episodes of care, a method that standardizes user-defined code groups, reviewing changes to episodes of care in codes/code groupings prior to finalizing the episodes of care into a common library set, and a method for guaranteeing the quality of the data associated with the episode of care, as well as the code libraries by enforcing a set of validation rules to prevent errant data, such as code duplicates to different code groupings.

In order to implement one or more of the operations identified above, the Episode Builder may include one or more of the following features, a grouping interface to create new episode of care names (user defined), a grouping interface to create user-defined coding categories within episodes of care—these are for typical diagnosis categories, typical procedure categories, core-service categories, complication categories, pharmacy categories etc., interactive/relational links to medical and pharmacy codes & descriptors, interactive/relational links to pre-grouped codes (select a block of codes), hold codes into new categories and move categories as blocks, find codes that are duplicated across categories, find codes that have “not” been selected from a category, an a-1a-carte of codes and pre-grouped code categories included in the application. Examples of codes and code categories are ICD-9, CPT/HCPC codes with descriptions, AHRQ-CCS categories, CMS-HCC categories etc. Other exemplary code and pre-grouped code category lists may include, ICD-9 Dx codes and descriptions, ICD-10 Dx codes and descriptions, ICD-9 procedure codes and descriptions, CPT/HCPCS codes and descriptions, DRG codes and descriptions (MS-DRG codes, APR-DRG codes), Revenue Codes, AHRQ-CCS pre-grouped code sets, CMS-HCC groupings, AHRQ-PSI, CMS-HAC code sets, NDC codes and Rx-Norm categories, NDC codes and Multum (Lexicom) groupings and BETOS classification.

The Episode Builder may include the following components, which may be implemented as software, hardware and/or a combination of software and hardware. The Episode Builder may include one or more Code Tables at INPUTS that may have codes and descriptors available such as ICD-9, ICD-10, CPT/HCPCS, NDC, and may have pre-grouped code categories such as from AHRQ-CCS, AHRQ-PSIs, CMS-HCC, CMS-HACs available. The Episode Builder may also include an Episode Master that is configured to create user defined episode numbers, names, and episode of care acronyms. The naming convention that may be used by the Episode Master may be that the episode of care name starts with the letter E followed by a letter A=acute medical, C=Chronic, P=Procedural, O=Other, the next two digits of the episode of care number are based on the Major Diagnostic Category (MDC): this field defines to which MDC the episode belongs (05=Circulatory MDC) and uses the standard CMS convention, and the next two digits are a computer generated unique number for each episode of care within an MDC, e.g., EA0501 could be the number for AMI—acute medical episode for circulatory MDC, and EC0501 could be the number for CHF—chronic medical episode for circulatory MDC. The episode of care description may be a text description of the episode, e.g. congestive heart failure, and the episode of care acronym may be an abbreviated episode name, e.g. CHF. The Episode Builder may also include a creator of user-defined categories (Code Groups) that may be configured to create user-defined category numbers and names (code groups). The naming convention that may be used is that the Code Groups start with the letter CG, the next two digits of the category number are based on the MDC (major diagnostic category) and the second two digits are computer generated unique category specific number, e.g. CG0501 is the first code group for circulatory MDC.

The Episode Builder may still further include a selector that is configured to select or deselect codes or code groups from available code tables in user-defined work space, and may also be configured to link selected codes/code groups into user-defined categories. The Episode Builder may also include a reconciler that is configured to identify codes that are duplicated across categories, and further configured to identify codes that have “not” been selected from a pre-grouped category. The Episode Builder may also include an updater that may be configured to update codes from time-to-time and easily update episode of care service categories accordingly. The Episode Builder may also include a creator of user-defined risk factors that may be configured to create user-defined risk factor numbers and names. The user-defined risk factors are derived from CMS-HCC, or based out of the user-defined code groups. The naming convention that may be used includes risk factors that start with the letters RF, the next two digits of the risk factor number are based on the MDC (major diagnostic category) and the second two digits are a computer generated unique risk factor specific number, e.g. RF0501 is the first risk factor for circulatory MDC.

The Episode Builder may also be configured to produce one or more output tables. One output table that may be produced is a consolidated workbook, these workbooks create Excel table outputs of codes, code names, user-defined categories, category names across selected episodes, for each of the following components of an episode of care, typical diagnosis codes, typical procedure codes, core services, complications, pharmacy, DRG mappings and risk factors. Tables 7-11 below show exemplary consolidated workbooks that may be created with the Episode Builder in accordance with the present invention. It is understood that the exemplary tables below are only for illustration purposes, and some columns are omitted from the examples below. It is understood that the complete table outputs consist of the codes that fall into each category as well as the code descriptions.

TABLE 7
Consolidated Workbooks for clean-up and vetting by CWGs

| | | | | | | | CAD | | | | CHF | | | |
|---|---|---|---|---|---|---|---|---|---|---|---|---|---|---|
| | | | | | | | | | Trig- | | | | Trig- | |
| RF_# | Category_Description | DX_Codes | Dx_Codes | PX_Codes | s | s | S | Core | ger | NS | S | Core | ger | NS |
| var03 | Physician Services | | | | G0108 | | | 2 | | | | 2 | | |
| var03 | Physician Services | | | | 99214 | | | 4 | | x | | 6 | | x |
| var03 | Physician Services | | | | 99212 | | | 4 | | x | | 6 | | x |
| var03 | Physician Services | | | | 99211 | | | 4 | | x | | 6 | | x |
| T2301 | After care, | V570 | | | | | | | | x | | | | x |
| | Rehabilitation | | | | | | | | | | | | | |
| T2301 | After care, | V571 | | | | | | | | x | | | | x |
| | Rehabilitation | | | | | | | | | | | | | |
| T2301 | After care, | V5721 | | | | | | | | x | | | | x |
| | Rehabilitation | | | | | | | | | | | | | |
| CRF20 | Cardiac Arrhythmias | 7850 | | | | | x | | | | x | | | |
| CRF20 | Cardiac Arrhythmias | 7851 | | | | | x | | | | x | | | |
| CRF20 | Cardiac Arrhythmias | 4270 | | | | | x | | | | x | | | |
| CRF20 | Cardiac Arrhythmias | 4271 | | | | | x | | | | x | | | |

TABLE 8
Consolidated Typical Diagnoses Workbook

| Typical Diagnosis Categories | CAD | AMI | CABG | PCI | CHF | COPD | Asthma | Pneum | Diabetes |
|---|---|---|---|---|---|---|---|---|---|
| Other cardio-respiratory symptoms | x | x | x | x | x | x | x | x | x |
| Long-term use of drugs | x | x | x | x | x | x | x | x | x |
| After care, rehabilitation | x | x | x | x | x | x | x | x | x |
| Cardiac arrhythmias | x | x | x | x | x | x | x | x | x |
| Premature beats, SA node dysfunction | x | x | x | x | x | | | | x |
| Conduction disorders, heart blocks | x | x | x | x | x | | | | x |
| Hyperlipidemia | x | x | x | x | x | | | | x |
| Hypertension, other heart disease | x | x | x | x | x | | | | x |
| Long-term use of anticoagulants, aspirin | x | x | x | x | x | | | | x |

TABLE 9
Consolidated Typical Procedures Workbook

| Sufficient Service Categories | CAD | AMI | CABG | PCI | CHF | COPD | ASTHMA | Pneum | Diabetes |
|---|---|---|---|---|---|---|---|---|---|
| Anesthesia, Intra-thoracic Procedures | x | x | x | x | x | | | x | |
| Pacemaker, Defibrillator Implantation, Leads | x | x | x | x | x | | | | |
| IABP | x | x | x | x | x | | | | |
| Chest X-Ray | x | x | x | x | x | x | x | x | |
| CT Scan Chest | x | x | x | x | x | x | x | x | |
| MRI/MRA Chest | x | x | x | x | x | x | x | x | |
| Cardiac MRI | x | x | x | x | x | | | | |

TABLE 10
Consolidated Complication Diagnoses Workbook

| Complication | Compl | Episodes | | | | | | | | |
|---|---|---|---|---|---|---|---|---|---|---|
| Categories | Type | CAD | AMI | CABG | PCI | CHF | COPD | Asthma | Pneum | Diab |
| Acute CHF, Pulm Edema | 1 | X | X | X | X | X | | | | |
| Hypertensive | 1 | X | X | X | X | X | | | | X |
| Encephalopathy, | | | | | | | | | | |
| Malignant Hypertension | | | | | | | | | | |
| Arterial | 1 | X | X | X | X | X | | | | X |
| Thromboembolism | | | | | | | | | | |
| Complication Of | 1 | X | X | X | X | X | | | | |
| Implanted Device, Graft | | | | | | | | | | |
| Complications After | 1 | | | X | | | | | | |
| Heart Surgery | | | | | | | | | | |
| Complications After PCI/ | 1 | | | X | X | | | | | |
| CABG | | | | | | | | | | |

TABLE 11
Consolidated Place of Service Over-ride Workbook

| Place of Service Over-ride | | | | | | | | | |
|---|---|---|---|---|---|---|---|---|---|
| Acute Exacerbations of Chronic | Episodes | | | | | | | | |
| Conditions | CAD | AMI | CABG | PCI | CHF | COPD | Asthma | Pneum | Diabetes |
| Stable CAD | x | x | x | x | | | | | |
| Angina | x | x | x | x | | | | | |
| Heart Failure, Cardiomyopathy | | x | x | x | x | | | | |
| Premature beats, SA node dysfunction | x | x | x | x | x | | | | |
| Cardiac Arrhythmias | x | x | x | x | x | x | x | x | |
| Other cardio-respiratory symptoms | x | x | x | x | x | x | x | x | |
| Hypertension, other heart disease | x | x | x | x | x | | | | x |
| Hyperlipidemia | x | x | x | x | x | | | | x |

The Episode Builder may also use metadata tables, such as an episode master table that lists all episodes of care created and shown for example in Table 12.

TABLE 12
Episode Master of user created episodes of care

| | | | | | Episode | |
|---|---|---|---|---|---|---|
| Eps | Eps Type | MDC | Eps # | Episode Description | Acronym | EpisodeCode |
| EC | Chronic | 05 | 01 | Coronary Artery Disease | CAD | EC0801 |
| EC | Chronic | 05 | 02 | Congestive Heart Failure | CHF | EC0802 |
| EA | Acute | 05 | 03 | Acute Myocardial Infarction | AMI | EA0801 |
| | Medical | | | | | |
| EP | Procedural | 05 | 11 | Coronary Artery Bypass Graft | CABG | EP0801 |
| EP | Procedural | 05 | 12 | Percutaneous Coronary | PCI | EP0802 |
| | | | | Intervention | | |

Furthermore, episode of care specific tables may be used, which are created for each episode of care and are captured within an All_codes file that contains the following code tables Triggers—Dx or Px driven, Typical Diagnosis Codes, Typical Procedure Codes—flagged as sufficient if they have a strong signal, Core Services (for chronic conditions)—identify optimum services for an episode, Complication codes flagged as type 1, 2, or 3, Associations—list of episodes associated to each other and if typical or PAC, Place of Service Over-ride—identifies Principal Dx codes on a stay claim that will flag the admission as a PAC, Pharmacy codes—NDC codes grouped into Prometheus Drug categories, Risk Factor Tables—Typical, complication categories specific to an episode brought in as risk factors for modeling predicted costs.

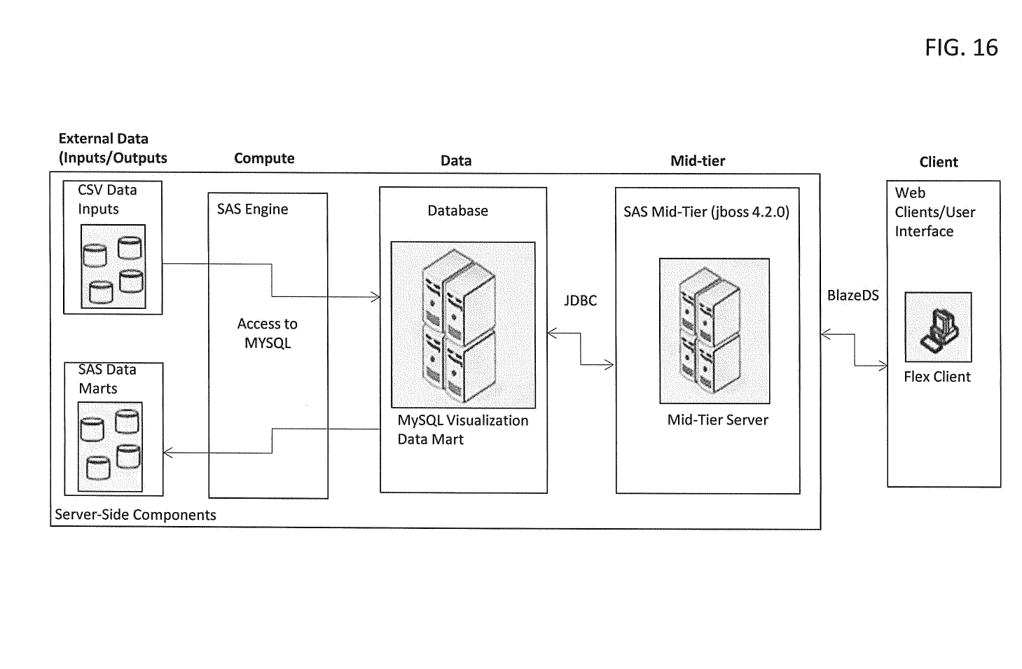

Referring now to FIG. 16, the overall architecture of the Episode Builder is illustrated therein. The Episode Builder may include external data inputs and outputs (Inputs/Outputs), a SAS engine or the like for transforming data (Compute), a MySQL data tier or the like for storing information (Data), a JBoss mid-tier or the like for hosting data and web services (Mid-tier), and a Flex client or the like for providing the user interface (Client). As shown in FIG. 16, the Episode Builder includes a number of hardware and/or software components for implementing the functions discussed above that can be performed by the Episode Builder. The data inputs and outputs include server side components such as CSV formatted data which can be stored on any of a number of hardware platforms, including hard drives, solid state memory and the like, and SAS data comprises hardware, including storage for data on hard drives, solid state memories or the like. The Compute section can be implemented on any computer server well-known in the art which may for example provides access to MySQL database information used in the SAS computing engine. The data itself which can be a MySQL database type data, represents visualization data for access by the user, such as a medical professional user or the like. The interconnection of this data from the Compute section to the Mid-tier processing section can be via Java Database Connectivity (JDBC). The Mid-tier processing section may include Mid-tier computer servers. In an embodiment of the present invention, these servers can operate using JavaBeans Open Source Software Application Server (JBOS AS) version 4.2.0. The interconnection between the Mid-tier processing section and the Client tool can be via a server-base Java remoting and web messaging technology (BlazeDS) that allows for connection to back-end distributed data and push data. The actual Client tool may be implemented on a web based browser. The Client tool may use Flex (for example, Apache Flex), a software development kit (SDK) for development and deployment of cross-platform rich internet applications based on the Adobe Flash platform. Furthermore, the software including the method of an embodiment of the present invention for implementing the Episode Builder can be embodied by computer program products well-known in the art. The computer program product includes non-transitory memory, such as hard disk, solid state memory and the like, as well as computer-readable program code portions stored thereon, including the instructions embodied in computer readable instructions for carrying out the processes associated with the architecture shown in FIG. 16. It should be noted that the computer architecture and the associated computer software for implementing the methodology can be implemented on different computer hardware and associated peripherals and that the software for implementing the various sections of the architecture may be implemented in various manners as well-known to those skilled in the art.

Code data is provided periodically to the system managers. These code files are in a standard CSV format. These code libraries run through a set of SAS programs to transform them into MySQL data. These ‘landing’ data tables are used to load the code libraries. Data can be exported for a specific episode of care or for the entire library. These exports match the output formats provided in Episode-specific Workbooks and File Layouts for SAS ready Metadata tables. Some outputs may be Excel-readable, while others may be SAS datasets, but it is understood that the present invention is not limited to any particular output type.

Still referring to FIG. 16, the SAS Engine (Compute) provides a mechanism for transforming external data into Episode-Builder code data. It also provides a mechanism for transforming episode of care and code data into standard formats of Excel and SAS datasets. This component comprises a set of SAS programs that work in concert to perform these transformations. The SAS Engine runs from the command-line of the hosting server. A mechanism for initiating imports and exports can also be performed from the Flex client. The MySQL database (Data) is the primary storehouse of data for the information required by the Episode Builder. Code data, episode of care data, and all associated metadata and application-metadata is stored in this repository, including user authentication and authorization information. All clients may use a single data repository for all information storage. The Episode Builder data model is a relational database used mainly to map codes to episodes of care. Exemplary components of the data may include Code, Rx to Multum, Episode, Episode Association, Episode to Code and Users.

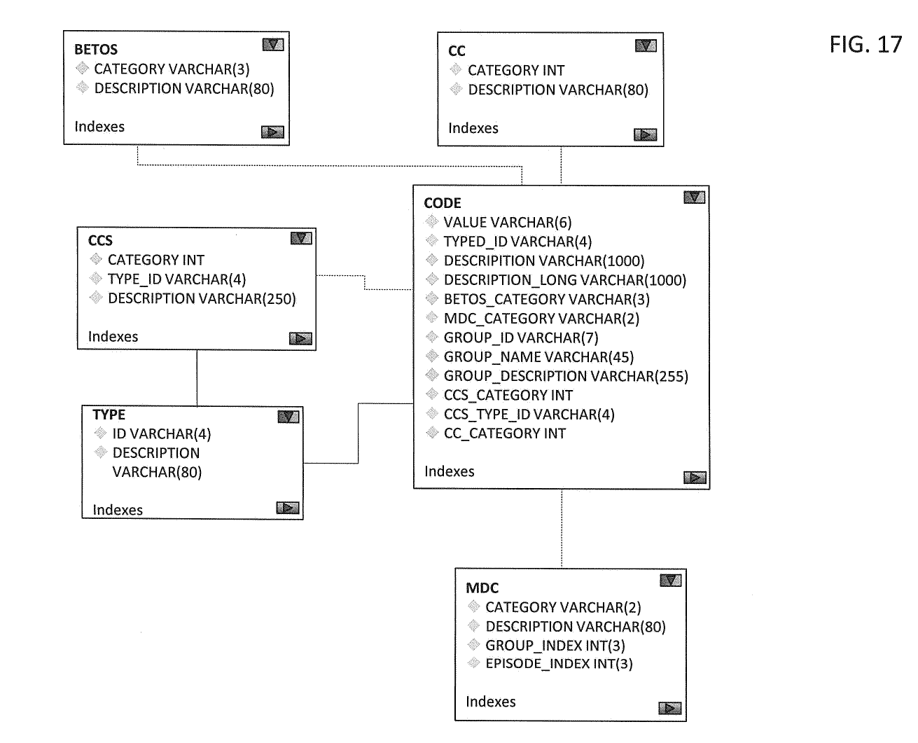

The Code component of the data may include diagnosis, procedure, CPT, and HCPC codes. Each code has its own type, and each code can belong to an MDC, CCS, BETOS, or CC category. The following set of rules may apply to the code data: Categories are assigned during the import process and categories are not deleted and can be saved from previous imports, since CCS categories can have the same id for different types such categories must also map to the type table to define their primary key, the MDC table contains metadata on both user groups and episode groups and neither of these fields have any relation to the codes that contain the same MDC, codes can be added to a single user generated code group and the group id of a new code group consists of the string “CG”, the MDC category, and latest group index with the code group information is also kept with each code, and codes can have a regular or long description. FIG. 17 provides a code table that contains code types that can map to an episode of care in one structure.

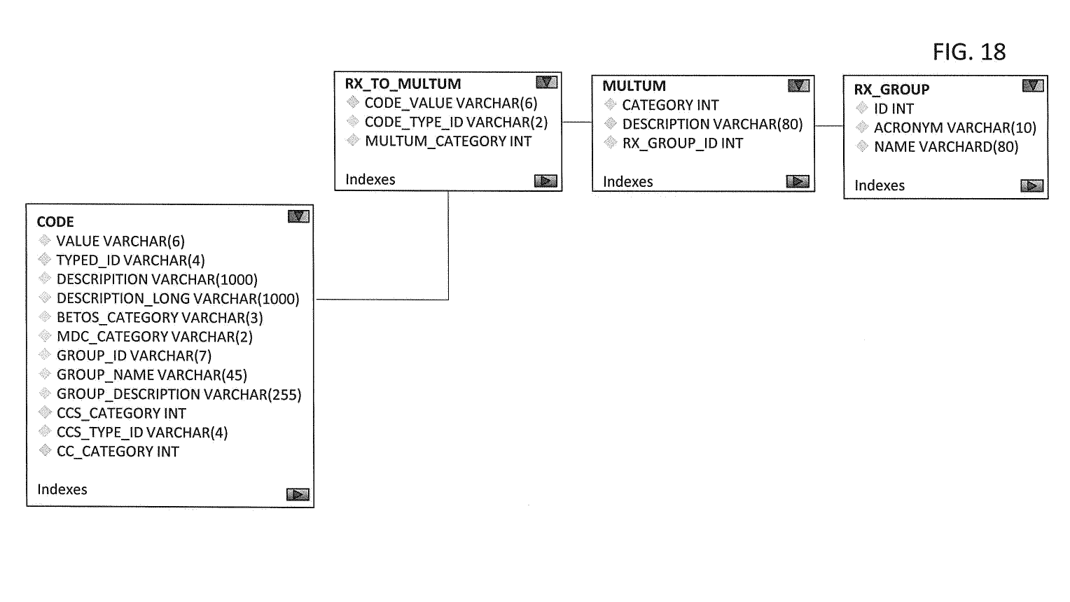

The relationship model of the Rx to Multum component of the data is shown in FIG. 18. Prescription codes or Rx codes are unique from other codes since they are assigned to Multum categories. Rx codes can also be assigned to multiple Multum categories. Since this represents a many to many relationship, an intermediate table is provided for Rx codes to map to Multum categories. Multum categories are defined during the import and can be saved from previous imports. Each Multum category can belong to one or more Rx groups, and Rx Groups are defined during the import process and are saved from previous imports.

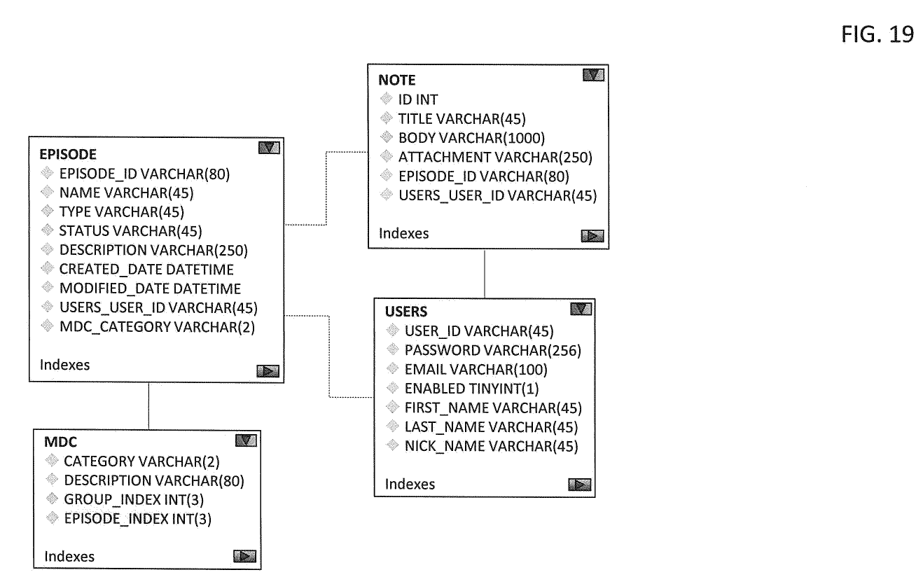

Referring now to FIG. 19, which shows episodes of care component of the data that are made by the user through the Episode Builder interface. The user that authored the episode of care, and date it was created, is stored in the episode of care when it is created. Episodes of care can belong to their own MDC category. Any time a code or note is added or removed from an episode of care the modified date is updated. Episodes of care have their own types which may be distinct from code types. The episode of care id is a string that is created by concatenating the episode type, MDC, and latest episode of care index together. The episode of care name and description are defined by the user when the episode of care is created. Episode of care status defines whether the episode of care is still in use or not. When an episode of care is removed the status changes to deleted and the episode of care no longer is displayed in the Episode Builder interface. However, the episode of care information will remain intact in the database, this feature may be useful in the case of accidentally deleting an episode of care. Episodes of care can have many notes, and each note may have a title, body, and possibly an attachment. The user that created the note is added when the note is created.

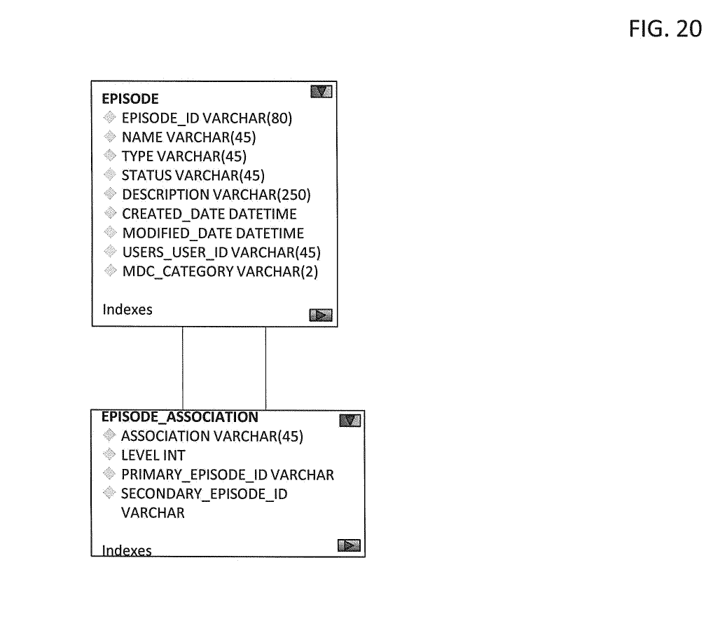

Referring now to FIG. 20, which illustrates that episodes of care can be linked together to represent an association, and represents the Episode Association component of the data of the Episode Builder. The strength of the association is represented by its level which ranges from 1-5. The level and association may be assigned by the user.

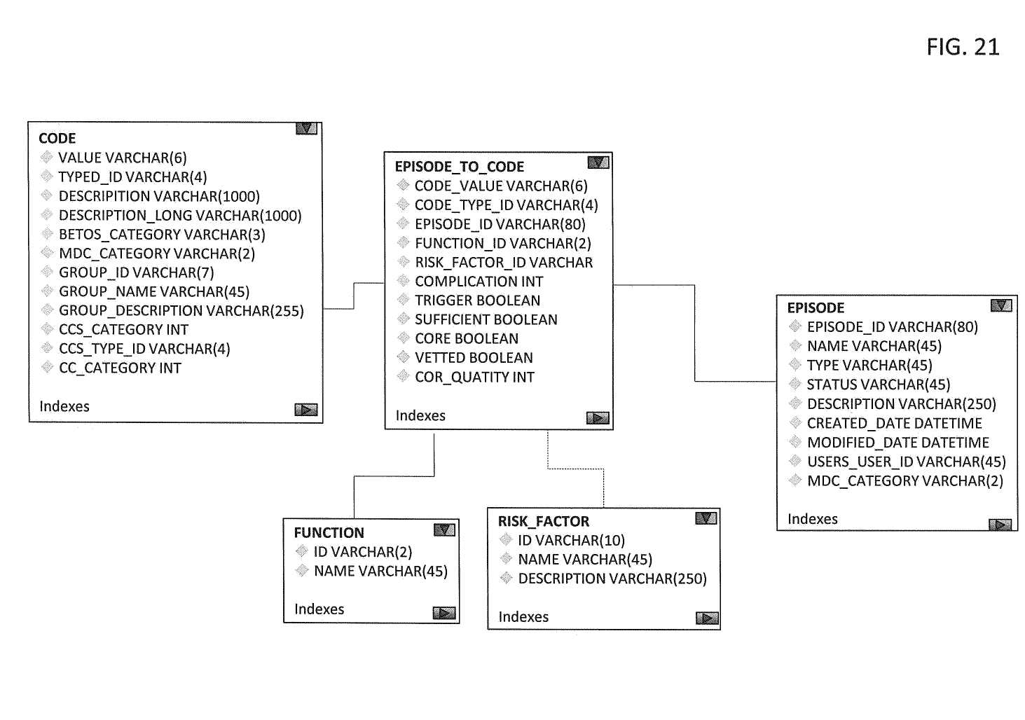

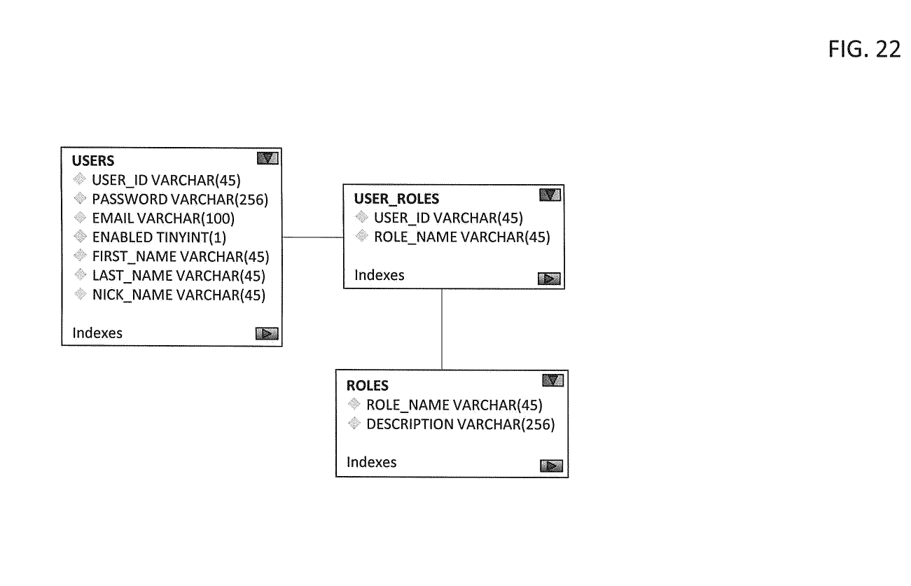

Referring now to FIG. 21, which illustrates the Episode_To_Code table component of the data that codes to episodes of care. Codes are added to an episode of care by the Episode Builder. The tab used in the Episode Builder to add that code is represented by the function id. When a code is added to an episode of care from the Trigger tab a function id of “TR” is assigned to the record of that episode of care. The same code could then be added from another tab. Risk factors groups may be created by the user, and the id consists of “RF”, a MDC code, and unique two digit index number. The remaining attributes of an Episode_To_Code entry may be set by the user when adding a code to an episode of care. FIG. 22 shows the User data component of the Episode Builder, and that users assigned in the Episode Builder can only be created by an Admin level user.

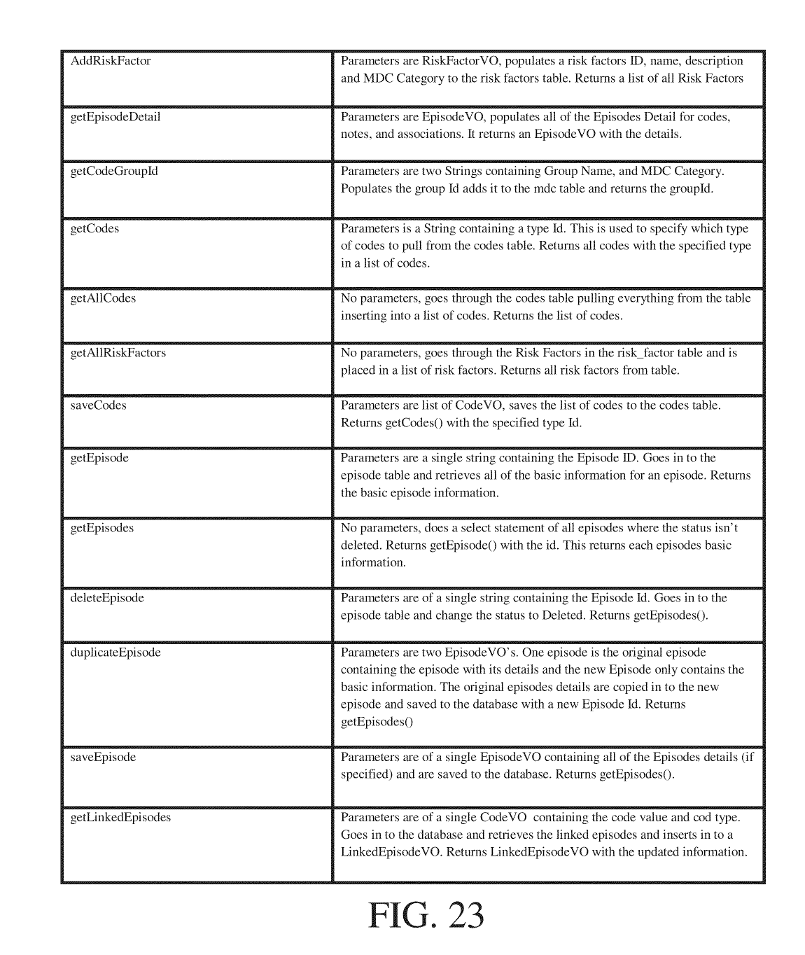

Referring again to FIG. 16, the Mid-tier component contains one or more functional services. These functional services of the Mid-tier component provide the functionality for modifying data, for validating data, for retrieving data, and for enforcing business rules and security rules. The Mid-tier component is the primary bridge between the Client component and the External Data, Compute and Data components. FIG. 23 provides a table showing exemplary web services that may be used to implement the functional services of the Episode Builder.

Referring again to FIG. 16, the Client component is the point of entry for all users of the Episode Builder. The user interface of the Client provides human-friendly interfaces for administering users, managing codes, managing episodes of care, and approving episodes of care. The Client may be implemented as a web-based, Flex application that runs inside a web browser with the Adobe Flash Player installed.

Exemplary embodiments of the Episode Builder according to the present invention can be deployed to most operating systems that support Java, SAS, and MySQL, for example an embodiment may be implemented on a Windows Server 2008.

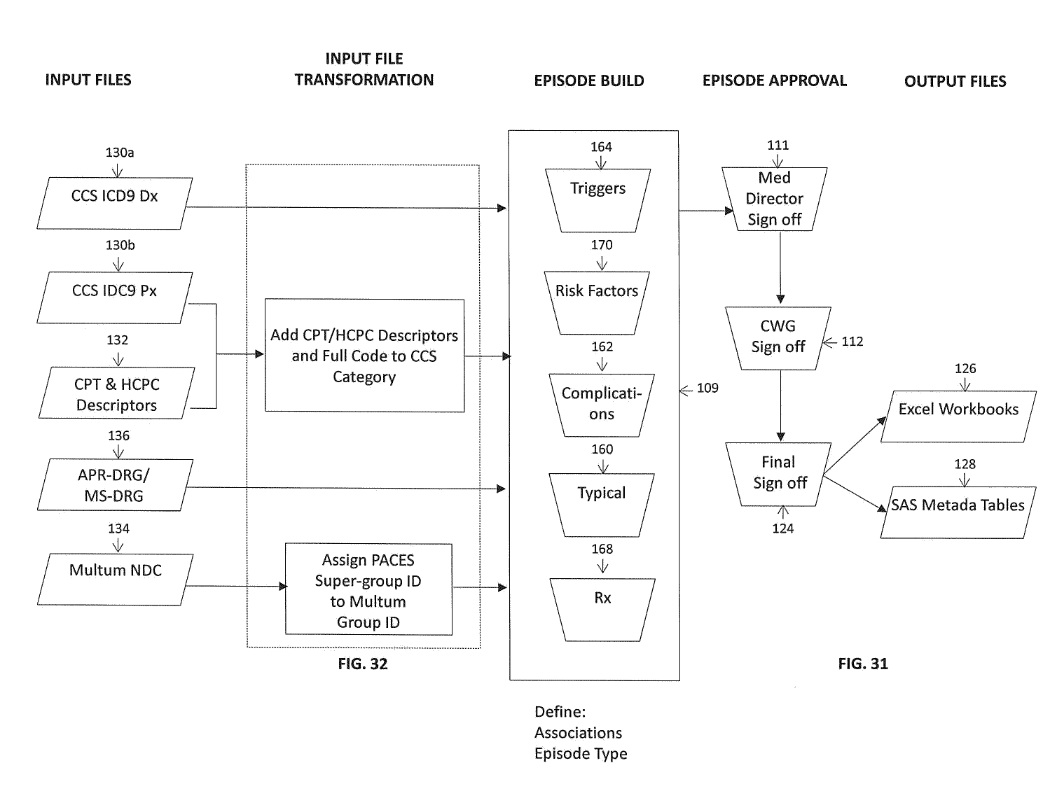

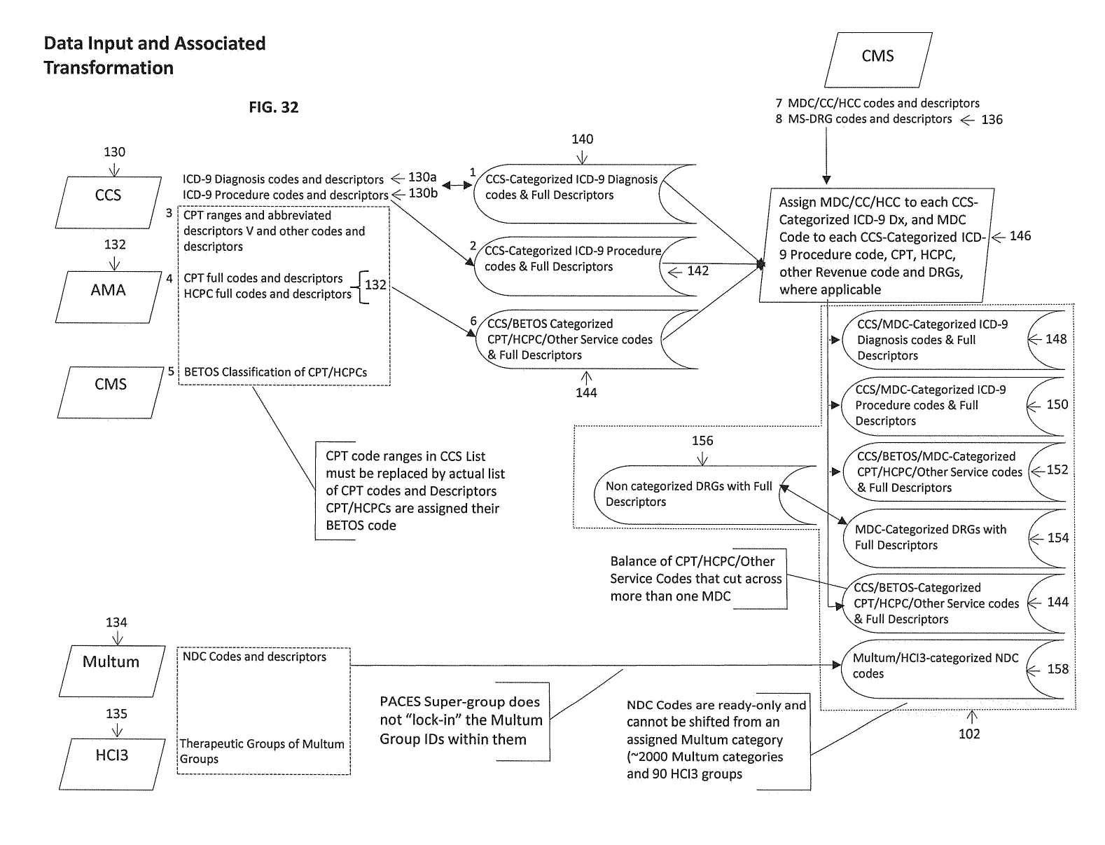

Referring now to FIGS. 31-36, which provide flowcharts of the process and information performed and/or used by the Episode Builder for generating and/or reviewing an episode of care according to the present invention. FIG. 31 in particular shows a general overview of the flow of the process and information according to the present invention. For example, the flow of the process and information generally begins with the input of medical code files, for example CSS ICD9 Dx 130a, CCS ICD9 Px 130b, CPT & HCPC Descriptors 132, APR-DRG/MS-DRG 136 and Multum NDC 134, into the code manager 14 (FIG. 1) of the Episode Builder 10. The input medical code files 130, 130a, 130b, 132, 134, 136 may then be subjected to transformation to produce categorized codes 102, as shown for example in FIG. 32. In FIG. 32, medical codes such as CSS 130, CSS ICD9 Dx 130a and CCS ICD9 Px 130b are processed and categorized according to established procedures to produce CSS-Categorized ICD-9 Diagnosis codes & Full Descriptors 140 and/or CCS-Categorized ICD-9 Procedure codes and Full Descriptors 142. These categorized codes and full descriptors 140, 142 may then be assigned MDC/CC/HCC in a step 146 to produce the CSS/MDC-Categorized ICD-9 Diagnosis codes & Full Descriptors 148 and CSS/MDC-Categorized ICD-9 Procedure codes & Full Descriptors 150 of the categorized codes 102. Furthermore, CPT ranges and abbreviated descriptors, V and other codes and descriptors, CPT full codes and descriptors and HCPC full codes and descriptors 132 and BETOS Classification of CPT/HCPCs may be categorized into CCS/BETHOS-Categorized CPT/HCPC/Other Service codes & Full Descriptors 144. These categorized codes & full descriptors 144 may then be assigned MDC/CC/HCC in the step 146 to produce CCS/BETOS/MDC-Categorized CPT/HCPC/Other Service codes & Full Descriptors 152 and CCS/BETOS-Categorized CPT/HCPC/Other Service codes & Full Descriptors 144 of the categorized codes 102.

Still referring to FIG. 32, CC/HCC to ICD codes and descriptors and MS-DRG codes and descriptors 136 may be assigned MDC/CC/HCC in the step 146 to produce MDC-Categorized DRGs with Full Descriptors 154 of the categorized codes 102, and non categorized DRGs with Full Descriptors 156 that are also included in the categorized codes 102. In addition, Multum NDC Codes and descriptors 134 and HC13 Therapeutic Groups of Multum Groups 135 may simply be added to the categorized codes 102 as Multum/HC13-categorized NDC codes 158 without any further modification and/or classification.

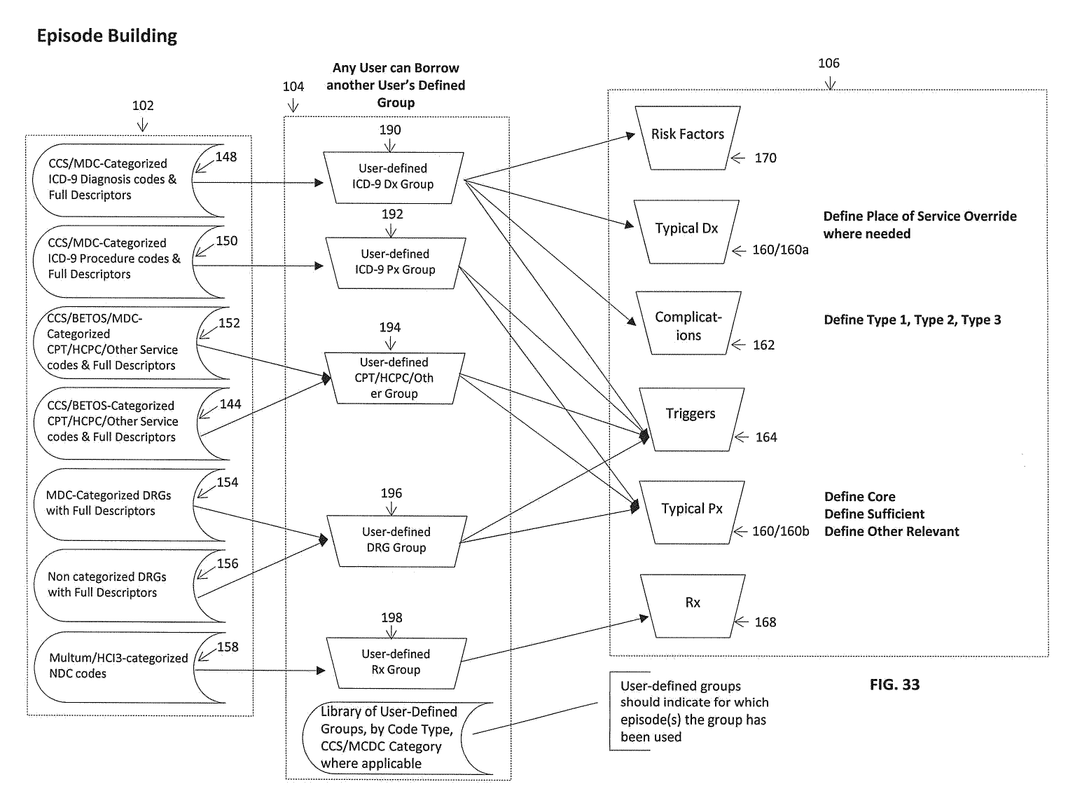

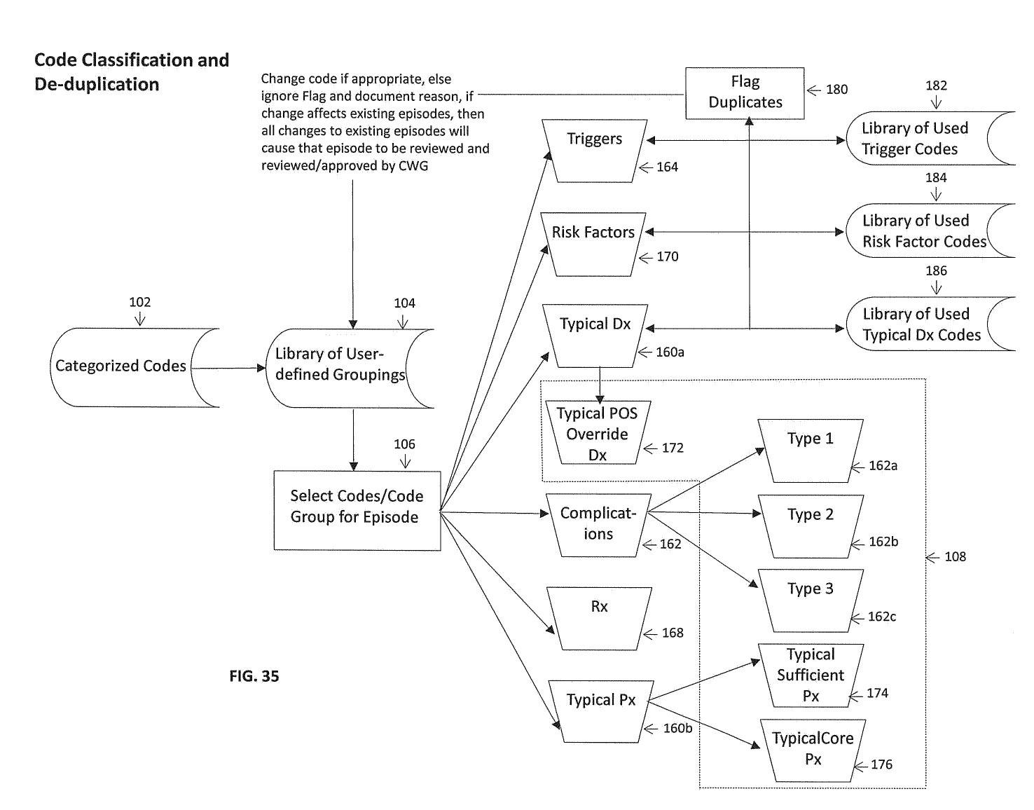

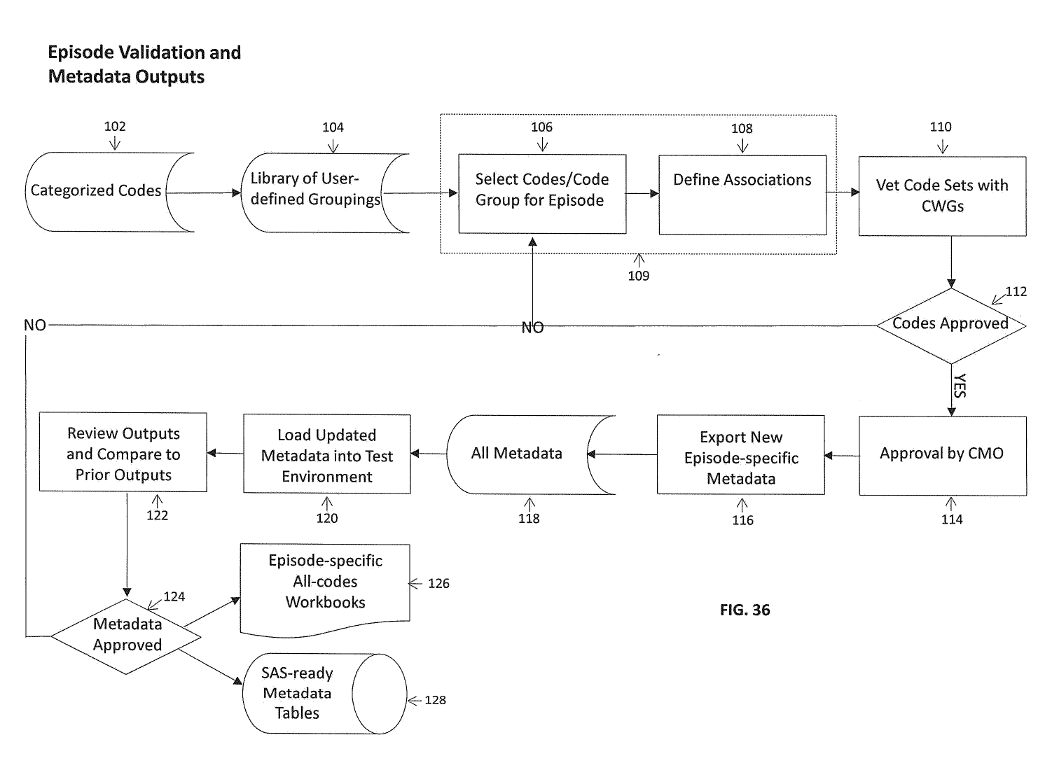

As shown generally in FIGS. 35 and 36, the categorized codes 102 are then assigned to a library of user-defined groupings 104. FIG. 33 provides additional details regarding the assignment of user defined groups. For example, the CCS/MDC-Categorized ICD-9 Diagnosis codes and Full Descriptors 148 may be assigned to a User-defined ICD-9 Dx Group 190. The CCS/MDC-Categorized ICD-9 Procedure codes & Full Descriptors 150 may be assigned to a User-defined ICD-9 Px Group 192. The CCS/BETOS/MDC-Categorized CPT/HCPC/Other Service codes & Full Descriptors 152 and CCS/BETOS-Categorized CPT/HCPC/Other Service codes & Full Descriptors 144 may be assigned to a User-defined CPT/HCPC/Other group 194. Furthermore, the MDC-Categorized DRGs with Full Descriptors 154 and Non-categorized DRGs with Full Descriptors 156 may be assigned to a User-defined DRG Group 196. Finally, the Multum/HC13-categorized NDC codes may be assigned to a User-defined Rx Group 198.

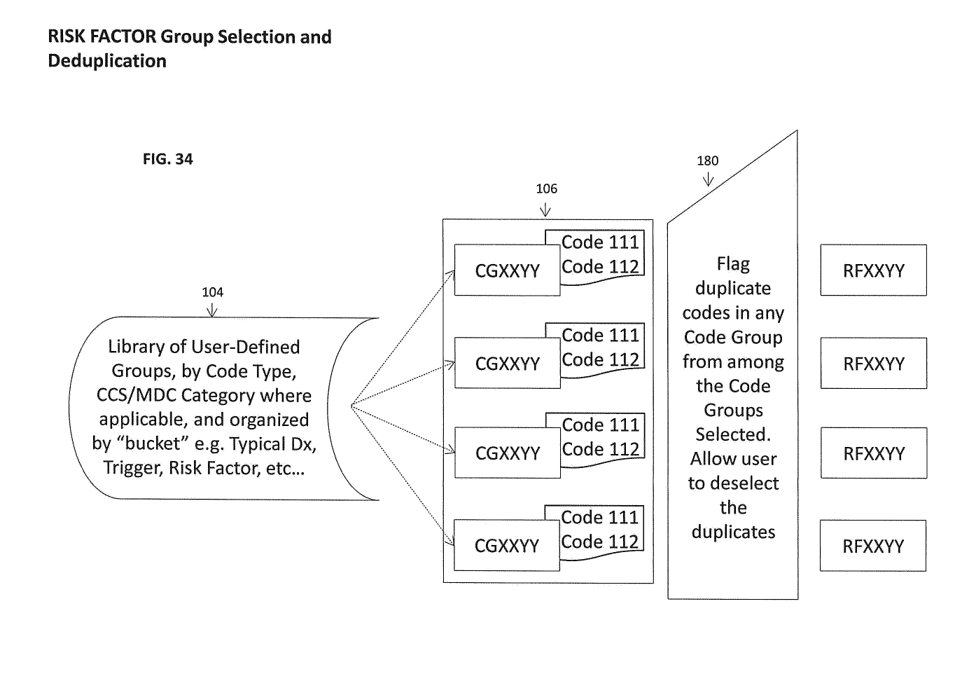

Referring now to FIGS. 31, 33 and 35-36, the episode build process 109 includes a step of selecting codes/code groups for the episode of care 106 and a step of defining episode of care associations 108. The step 106 of selecting user defined groupings 104 for inclusion in a particular episode of care is show in greater detail in FIG. 33. In FIG. 33, the medical codes from the User-defined ICD-9 Dx Group 190 may be selected as a typical Dx 160a, a complication 162 and/or a trigger 164. Furthermore, medical codes from the User-defined ICD-9 Px Group 192 may be selected as a trigger 164 and/or a typical Px 160b. Medical codes from the User-defined CPT/HCPC/Other Group 194 may be selected as a trigger 164 and/or a typical Px 160b. Medical codes from the User-defined DRG Group 196 may be selected a trigger 164 and/or a typical Px 160b, and medical codes from the User-defined Rx Group 198 may be assigned as a Rx 168. The step 106 of selecting user defined groupings 104 may also include selecting medical codes as risk factors 170, as shown for example in FIG. 35. It is understood that the selection and assignment of the various medical codes from the various groups is the process performed by the Episode Builder according to the present invention that has been discussed in greater detail above. For example, FIG. 34 provides a greater detail of an exemplary selection of medical cods from the library of user-defined groups 104 during the step of selecting codes and/or code groups 106 for an episode of care.

Referring now to FIGS. 35 and 36, the step 108 of defining episode of care associations from the medical codes assigned to the episode of care in step 106 is shown in greater detail in FIG. 35. The step 108 of defining episode of care associations may include identifying typical POS override Dx codes 172 from the typical Dx codes 160a. Furthermore, the step 108 may also include identifying Type 1 162a, Type 2 162b and Type 3 162c complications from the medical codes that have been associated as complications 162 of the episode of care. In addition, the step 108 may also include identifying typical sufficient Px codes 174 and/or typical core Px codes 176 from the typical Px codes 160b assigned to the particular episode of care. FIG. 35 also demonstrates that when a trigger 164, risk factor 170 and/or typical Dx 160a medical code is assigned to the episode of care, a library of used trigger codes 182, a library of used risk factors 184 and a library of used typical Dx codes 186 are created in order to allow for a step 180 of flagging and/or identifying duplicate codes. For any duplicate codes that are identified the user may be provided with the option of either changing the code if appropriate or deselecting the duplicate. In the alternative, the user may ignore the flagged duplicate and document a reason within the Episode Builder as to why the duplicate was left. If a change affects existing episodes of care, then all changes to existing episodes of care require reapproval, as discussed further below.

Referring now to FIGS. 31 and 36, the episode of care approval and verification component of the episode building process will now be discussed. FIG. 31 shows the general steps associated with the episode approval component. For example, the episode approval component may include a sign off by a medical director step 111, a CWG sign off step 112 and a final sign off step 124. FIG. 36 shows additional steps that may be included in this component of the episode builder process. For example, during the code approval step 112, if the codes are not approved, then the overall process may return to step 106. Once the codes have been approved by a CMO in step 114, new episode of care specific metadata is exported in a step 116, and then may be included in all of the metadata 118 of the Episode Builder. The updated metadata 118 may then be loaded into a test environment in step 120 in which medical claims are compared with the episode of care metadata to produce outputs related to the medical claims. In step 122, these outputs are reviewed and compared to prior outputs, and based upon the review and comparison the metadata may be approved in step 124. If approved, then episode specific workbooks 126 and/or SAS metadata tables 128 are provided, as discussed above, and if the metadata is not approved, then the process returns to step 106.

Thus what has been described is an Episode Builder method and system that allows healthcare professional to create, edit, review and distribute episodes of care.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method of defining and/or editing medical episodes of care, comprising:
providing a library of medical codes;
providing a user interface to allow a user to create, edit, review and distribute an episode of care based on said medical codes; and
wherein providing a user interface to allow a user to create, edit, review and distribute an episode of care includes providing episode quality control associated with the defined episode of care to ensure that the episode of care does not conflict with at least one previously defined episode of care.

2. The method according to claim 1, wherein the medical codes can include any of diagnostic codes, procedure codes and pharmacy codes.

3. The method according to claim 1, wherein providing a user interface to allow a user to create, edit, review and distribute an episode of care includes assigning episode of care parameters, grouping medical codes and other episodes of care into episode function assignments.

4. The method according to claim 1, wherein providing a user interface to allow a user to create, edit, review and distribute an episode of care includes an episode function assignment that allows the user to assign medical codes or other defined episodes of care that are relevant to the episode of care that is edited by the user, wherein the medical code functions include any of the following:
indicating an episode of care has started, diagnosis of a condition, procedures that occur for the condition, condition complications, associations to other conditions, drugs used for the condition, and condition sub-types.

5. The method according to claim 1, wherein providing episode quality control includes an episode quality control display that provides to the user a list of potential problems or incompatibilities created with respect to the episode of care defined by the user and the at least one previously defined episode of care, as well as an indication of which assigned codes and parameters are associated with the list of problems.

6. A system for defining and editing medical episodes of care, comprising:
at least one processor, and at least one memory including program code, the at least one memory and the computer program code configured to, with the at least one processor, cause the system at least to perform:
providing a library of medical codes;
providing a user interface to allow a user to create, edit, review and distribute an episode of care based on said medical codes; and
wherein providing a user interface to allow a user to create, edit, review and distribute an episode of care includes providing episode quality control associated with the defined episode of care to ensure that the episode of care does not conflict with at least one previously defined episode of care.

7. The system according to claim 6, wherein the medical codes can include any of diagnostic codes, procedure codes and pharmacy codes.

8. The system according to claim 6, wherein providing a user interface to allow a user to create, edit, review and distribute an episode of care includes assigning episode of care parameters, grouping medical codes and other episodes of care into episode function assignments.

9. The system according to claim 6, wherein providing a user interface to allow a user to create, edit, review and distribute an episode of care includes an episode function assignment that allows the user to assign medical codes or other defined episodes of care that are relevant to the episode of care that is edited by the user, wherein the medical code functions include any of the following: indicating an episode of care has started, diagnosis of a condition, procedures that occur for the condition, condition complications, associations to other conditions, drugs used for the condition, and condition sub-types.

10. The system according to claim 6, wherein providing episode quality control includes an episode quality control display that provides to the user a list of potential problems or incompatibilities created with respect to the episode of care defined by the user and the at least one previously defined episode of care, as well as an indication of which assigned codes and parameters are associated with the list of problems.
